(19) United States
(12) Patent Application Publication
(10) Pub. No.: US 2025/0008528 A1
(43) Pub. Date: Jan. 2, 2025

(54) BASE STATION, TERMINAL, AND COMMUNICATION METHOD

(71) Applicant: Panasonic Intellectual Property Corporation of America, Torrance, CA (US)

(72) Inventors: Ayako HORIUCHI, Kanagawa (JP); Hidetoshi SUZUKI, Kanagawa (JP); Quan KUANG, Langen (DE); Hongchao LI, Langen (DE)

(21) Appl. No.: 18/712,204

(22) PCT Filed: Oct. 6, 2022
(86) PCT No.: PCT/JP2022/037369

§ 371 Date: May 21, 2024

(30) Foreign Application Priority Data
Dec. 3, 2021 (JP) 2021-196917

(51) Int. Cl. H04W 72/232; H04L 5/00; H04W 52/24

(52) U.S. Cl. CPC H04W 72/232; H04L 5/0048; H04W 52/243

(57) ABSTRACT

This base station comprises: a control circuit that determines information relating to the presence or absence of at least one setting among a frequency gap with respect to resource allocation of signals, and a reduction in transmission power with respect to the signals; and a transmission circuit that notifies a terminal of the information.

### TECHNICAL FIELD

The present disclosure relates to a base station, a terminal, and a communication method.

### BACKGROUND ART

Studies have been carried out on communication systems so called the 5th Generation mobile communication systems (5G). In 5G, studies have been carried out on flexibly providing functions for each of use cases which require an increase in communication traffic, an increase in the number of terminals to be connected, high reliability, and low latency. Typical use cases include the following three: enhanced Mobile Broadband (eMBB); massive Machine Type Communications (mMTC); and Ultra Reliable and Low Latency Communications (URLLC). In the 3rd Generation Partnership Project (3GPP), which is an international standardization organization, further advancement of communication systems has been under study in both aspects of advancement of the LTE systems, and New Radio (NR).

### CITATION LIST

### Non Patent Literature

NPL 1
3GPP TS38.213 V16.7.0, “NR Physical layer procedures for control (Release 16),” 2021-09.
NPL 2
3GPP TS38.214 V16.7.0, “NR Physical layer procedures for data (Release 16),” 2021-09.
NPL 3
RP-212667. “Moderator's summary for discussion [RAN94e-R18Prep-07] Evolution of Duplex Operation Document for: Information & Decision,” Samsung

### SUMMARY OF INVENTION

However, there is room for further study on a method of suppressing signal interference in radio communication.

One non-limiting and exemplary embodiment facilitates providing a base station, a terminal, and a communication method each capable of suppressing signal interference in radio communication.

A base station according to a non-limiting and exemplary embodiment of the present disclosure includes: control circuitry, which, in operation, determines, on resource allocation for a signal, information on the presence or absence of at least one configuration of a frequency gap and/or a reduction in transmission power for the signal; and transmission circuitry, which, in operation, indicates the information to a terminal.

It should be noted that general or specific embodiments may be implemented as a system, an apparatus, a method, an integrated circuit, a computer program, a storage medium, or any selective combination thereof.

According to a non-limiting embodiment of the present disclosure, it is possible to suppress signal interference in radio communication

Additional benefits and advantages of the disclosed aspects will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates operation examples of base stations and terminals;

FIG. 2 is a block diagram illustrating a configuration focused on part of a base station according to Embodiment 1;

FIG. 3 is a block diagram illustrating a configuration focused on part of a terminal according to Embodiment 1;

FIG. 4 is a block diagram illustrating a configuration of the base station according to Embodiment 1;

FIG. 5 is a block diagram illustrating a configuration of the terminal according to Embodiment 1;

FIG. 6 is a sequence diagram illustrating exemplary operations of the base station and the terminal according to Embodiment 1;

FIG. 7 illustrates an exemplary configuration of a frequency gap in Embodiment 1;

FIG. 8 illustrates another exemplary configuration of a frequency gap in Embodiment 1:

FIG. 9 illustrates still another exemplary configuration of a frequency gap in Embodiment 1;

FIG. 10 illustrates still another exemplary configuration of a frequency gap in Embodiment 1;

FIG. 11 illustrates still another exemplary configuration of a frequency gap in Embodiment 1;

FIG. 12 illustrates yet another exemplary configuration of a frequency gap in Embodiment 1;

FIG. 13 is a block diagram illustrating a configuration of a base station according to Embodiment 2;

FIG. 14 is a block diagram illustrating a configuration of a terminal according to Embodiment 2;

FIG. 15 illustrates an exemplary configuration of transmission power in Embodiment 2:

FIG. 16 illustrates another exemplary configuration of transmission power in Embodiment 2;

FIG. 17 illustrates still another exemplary configuration of transmission power in Embodiment 2;

FIG. 18 illustrates still another exemplary configuration of transmission power in Embodiment 2;

FIG. 19 illustrates yet another exemplary configuration of transmission power in Embodiment 2;

FIG. 20 illustrates an exemplary architecture for a 3GPP NR system;

FIG. 21 is a schematic diagram illustrating functional split between a next generation-radio access network (NG-RAN) and 5th generation core (5GC);

FIG. 22 is a sequence diagram for radio resource control (RRC) connection setup/reconfiguration procedures;

FIG. 23 is a schematic diagram illustrating usage scenarios of enhanced mobile broadband (eMBB), massive machine type communications (mMTC), and ultra reliable and low latency communications (URLLC); and

FIG. 24 is a block diagram illustrating an exemplary 5G system architecture for a non-roaming scenario.

### DESCRIPTION OF EMBODIMENTS

Hereinafter, embodiments of the present disclosure will be described in detail with reference to the accompanying drawings.

In NR, for example, a terminal (User Equipment (UE)) may be configured with a plurality of control resource sets (hereinafter each referred to as “CORESET”) and a search space, which is a position of a PDCCH candidate in the CORESET, as a region for a Physical Downlink Control Channel (PDCCH) that is a control signal channel on (through) which downlink control information (e.g., Downlink Control Information (DCI)) is arranged (or transmitted). For example, the terminal monitors (performs Blind Decoding on) the search space in the CORESET to detect the DCI.

Further, in NR, for example, symbol configuration in a slot, such as a Downlink (DL) symbol, an Uplink (UL) symbol, and a Flexible symbol, is configured (or specified) for the terminal, using a slot format indicator (SFI).

A symbol configuration method includes, for example, a plurality of methods as follows:
1. Configuration by “Tdd-UL-DL-ConfigurationCommon” included in a System Information Block (SIB) transmitted in units of cells;
2. Configuration by “Tdd-UL-DL-ConfigurationDedicate” included in Radio Resource Control (RRC) individually transmitted to each UE;
3. Configuration by “SlotFormatIndicator” included in a DCI transmitted in units of groups (e.g., DCI format 2_0); and
4. Configuration by resource allocation information for DL or UL individually transmitted to each UE.

For example, Method 1 and Method 2 described above are each also referred to as a semi-static configuration (semi-static indication), whereas Method 3 and Method 4 are each also referred to as a dynamic configuration (dynamic indication).

Further, when the value ‘255’ is indicated in a situation where the SFI is configured in DCI format 2_0, a terminal may determine that there is no configuration in units of groups (e.g., group DCI is skipped). Further, for example, the terminal need not be configured with all of the symbol configuration methods of Methods 1 to 4 described above.

Further, for example, a DL symbol and an UL symbol that are configured by Method 1 or Method 2 are not overwritten with different links by Method 3 or Method 4 (e.g., overwrite DL with UL or UL with DL). Meanwhile, for example, a symbol that is configured to a Flexible symbol by Method 1 or Method 2 can be designated as a DL symbol or an UL symbol by Method 3 or Method 4. In addition, for example, a symbol that is configured to a Flexible symbol by Method 3 can be designated as a DL symbol or an UL symbol by Method 4.

There is no provision in NR to align DL or UL timing between base stations (also referred to as gNBs), for example. However, for example, when DL and UL are used simultaneously in the same resource or when DL and UL are used simultaneously in neighboring resources, interference between links (e.g., cross link interference (CLI)) may occur.

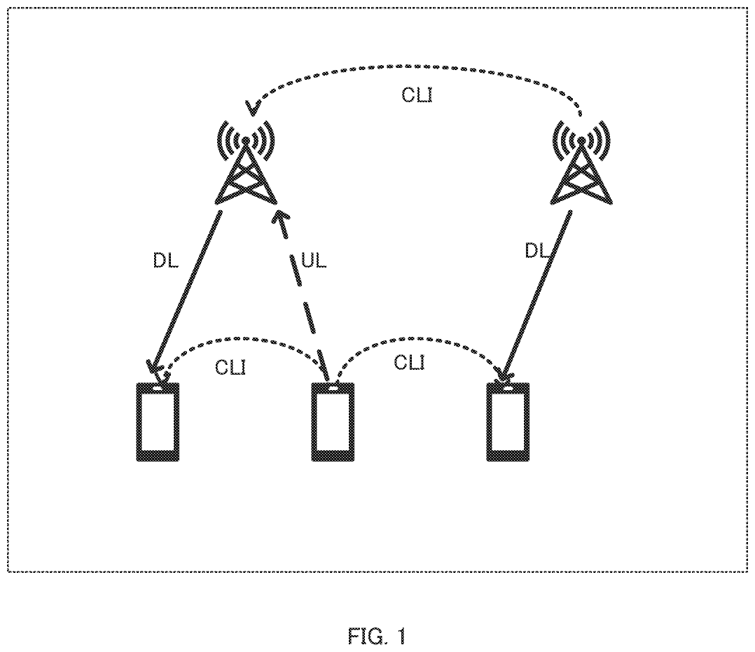

For example, as illustrated in FIG. 1, when base stations perform reception of an UL signal and transmission of a DL signal at the same timing, the UL signal from a terminal may cause interference (e.g., CLI) to a terminal that receives the DL signal in the same base station or a terminal that receives a DL signal of a neighboring cell. Additionally, for example, as illustrated in FIG. 1, when the DL configuration and the UL configuration vary between base stations, a DL signal transmitted by a base station may cause interference (e.g., CLI) to an UL signal received by the neighboring base station.

Thus, for example, depending on national legislations or adjustment among operators, it has been discussed to align a DL timing and an UL timing to avoid interference between DL and UL (e.g., CLI). Meanwhile, when a plurality of base stations are adjacent to each other, a voluntary operation may be performed in order to align a DL timing and an UL timing.

Further, in NR, for example, in a base station (or cell), since a different symbol configuration can be individually made for each terminal by a method (e.g., Method 2, 3, or 4) different from the configuration with the SIB of Method 1, UL can be allocated for a certain terminal (e.g., UE 1), and DL can be allocated for another terminal (e.g., UE 2) at the same timing. Such operation is unlikely to be assumed, however, because the interference between may UL and DL occur between neighboring frequency resources.

On the other hand, for example, 3GPP Release 18 (Rel. 18) or releases later than 18, in order to allocate resources more flexibly, it has been studied to allocate different links at the same timing in the same base station (or cell) (e.g., simultaneous DL/UL transmission and reception such as allocation of UL resource to UE 1 and allocation of DL resource to UE 2) (e.g., see NPL 3). For example, the simultaneous DL/UL transmission and reception may have various types, as follows.

Type 1: A base station simultaneously performs transmission and reception in DL and UL in different frequency resources. Either DL or UL is allocated to one terminal in the same time resource.

Type 2: A base station simultaneously performs transmission and reception in DL and UL in the same frequency resource. Either DL or UL is allocated to one terminal in the same time resource.

Type 3: A base station simultaneously performs transmission and reception in DL and UL in the same frequency resource. One terminal simultaneously performs transmission and reception in DL and UL in different frequency resources.

Type 4: A base station simultaneously performs transmission and reception in DL and UL in the same frequency resource. One terminal simultaneously performs transmission and reception in DL and UL in the same frequency resource.

Further, in NR, for example, studies have been carried out on transmission and reception without aligning a DL timing and an UL timing even between neighboring base stations.

In a non-limiting and exemplary embodiment of the present disclosure, a description will be given of a method of suppressing interference (e.g., CLI) given by a signal of one link to a signal of the other link when DL and UL are used in the same time resource in a frequency resource allocated to a terminal by a base station. For example, in a non-limiting and exemplary embodiment of the present disclosure, the base station may indicate, to the terminal, information for suppressing the interference in a case where DL and UL are used simultaneously.

### [Overview of Communication System]

A communication system according to each embodiment of the present disclosure includes base station 100 and terminal 200.

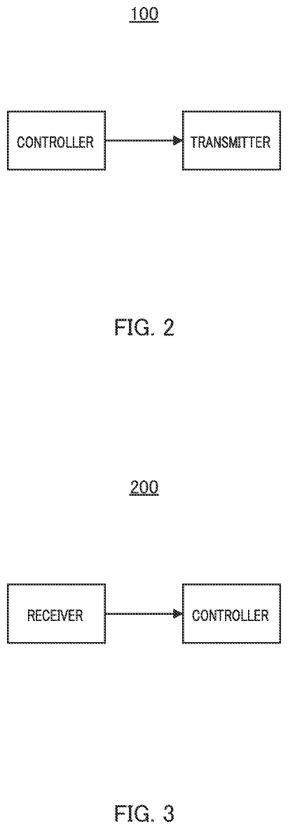

FIG. 2 is a block diagram illustrating a configuration focused on part of base station 100 according to an embodiment of the present disclosure. In base station 100 illustrated in FIG. 2, a controller (e.g., corresponding to control circuitry) determines, on resource allocation for a signal, information on the presence or absence of at least one configuration of a frequency gap and a reduction in transmission power for the signal (e.g., limitation on maximum transmission power or transmission power). A transmitter (e.g., corresponding to transmission circuitry) indicates the information to terminal 200.

FIG. 3 is a block diagram illustrating a configuration focused on part of terminal 200 according to an embodiment of the present disclosure. In terminal 200 illustrated in FIG. 3, a receiver (e.g., corresponding to reception circuitry) receives, on resource allocation for a signal, information on the presence or absence of at least one configuration of a frequency gap and a reduction in transmission power for the signal (e.g., limitation on maximum transmission power or transmission power). A controller (e.g., corresponding to control circuitry) determines, based on the information, the at least one configuration of the frequency gap and the reduction in transmission power.

### Embodiment 1

### [Configuration of Base Station]

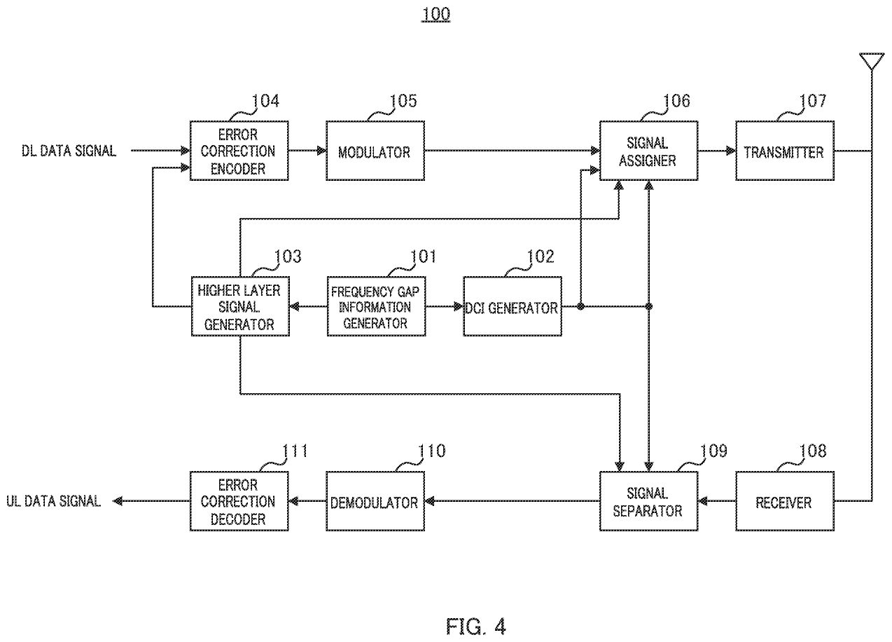

FIG. 4 is a block diagram illustrating a configuration of base station 100 according to the present embodiment. In FIG. 4, base station 100 includes frequency gap information generator 101. DCI generator 102, higher layer signal generator 103, error correction encoder 104, modulator 105, signal assigner 106, transmitter 107, receiver 108, signal separator 109, demodulator 110, and error correction decoder 111.

For example, at least one of frequency gap information generator 101, DCI generator 102, higher layer signal generator 103, error correction encoder 104, modulator 105, signal assigner 106, signal separator 109, demodulator 110, and error correction decoder 111, which are illustrated in FIG. 4, may be included in the controller illustrated in FIG. 2. Meanwhile, for example, transmitter 107 illustrated in FIG. 4 may be included in the transmitter illustrated in FIG. 2.

Frequency gap information generator 101 determines whether to configure a frequency gap in resource allocation to terminal 200 and determines, based on a determination result, configuration information on the configuration of the frequency gap (e.g., referred to as frequency gap information).

The frequency gap information may include, for example, at least information on the presence or absence of configuration of the frequency gap (may also be referred to as frequency gap configuration). Additionally, the frequency gap information may include, for example, at least one of information on the size of frequency gap and information on the position of frequency gap.

Frequency gap information generator 101 outputs the generated frequency gap information to higher layer signal generator 103. In addition, frequency gap information generator 101 outputs the frequency gap information to DCI generator 102 when indicating the frequency gap information to terminal 200 by a DCI, for example.

DCI generator 102 generates, for example, at least one of Downlink Control Information (DCI) that is a control signal for allocating DL data and a DCI that is a control signal for allocating UL data. Further, for example, DCI generator 102 may cause the frequency gap information input from frequency gap information generator 101 to be included in the DCI.

DCI generator 102 may, for example, output the generated DCI to signal assigner 106 as transmission data. For example, DCI generator 102 may output, to the signal assigner, the DCI for DL allocation as the control signal for allocating the DL data and the information on the frequency gap. Further. DCI generator 102 may, for example, output, to signal separator 109, the DCI for UL allocation as the control signal that indicates the position to which the UL data is allocated and the information on the frequency gap.

Higher layer signal generator 103, for example, generates, based on the frequency gap information input from frequency gap information generator 101, a higher layer signal (e.g., signal of RRC or Medium Access Control (MAC)) on the frequency gap and then outputs the generated signal to error correction encoder 104. Higher layer signal generator 103 may also output the frequency gap information to signal assigner 106 and signal separator 109, for example.

Error correction encoder 104 performs error correction encoding on a transmission data signal (DL data signal) and higher layer signaling input from higher layer signal generator 103, and then outputs the encoded signal to modulator 105.

Modulator 105 performs modulation processing on the signal received from error correction encoder 104 and outputs the modulated signal to signal assigner 106.

Signal assigner 106, for example, assigns, to a downlink resource, the signal received from modulator 105 (DL data signal) and the DCI that is the control signal received from DCI generator 102, based on the DL allocation information input from DCI generator 102. Meanwhile, signal assigner 106 need not assign a signal to a resource corresponding to the frequency gap in a case where, for example, the frequency gap is arranged to (or configured for) the downlink resource based on the frequency gap information input from higher layer signal generator 103 or DCI generator 102. In this manner, a transmission signal is formed. The formed transmission signal is output to transmitter 107.

Transmitter 107 performs radio transmission processing such as up conversion on the transmission signal input from signal assigner 106 and then transmits the resultant signal to terminal 200 via an antenna.

Receiver 108 receives the signal transmitted from terminal 200 via the antenna, performs radio reception processing such as down conversion on the received signal, and then outputs the resultant signal to signal separator 109.

Signal separator 109 separates, based on the UL allocation information input from DCI generator 102, an UL data signal from the received signal received from receiver 108 and then outputs the resultant signal to demodulator 110. Meanwhile, signal separator 109 need not output, to demodulator 110, a signal on a resource component corresponding to the frequency gap in a case where the frequency gap is arranged to (or configured for) an uplink resource based on the frequency gap information input from higher layer signal generator 103 or DCI generator 102, for example.

Demodulator 110 performs demodulation processing on the signal input from signal separator 109 and then outputs the obtained signal to error correction decoder 111.

Error correction decoder 111 decodes the signal input from demodulator 110 and thus obtains a received data signal (UL data signal) from terminal 200.

### [Configuration of Terminal]

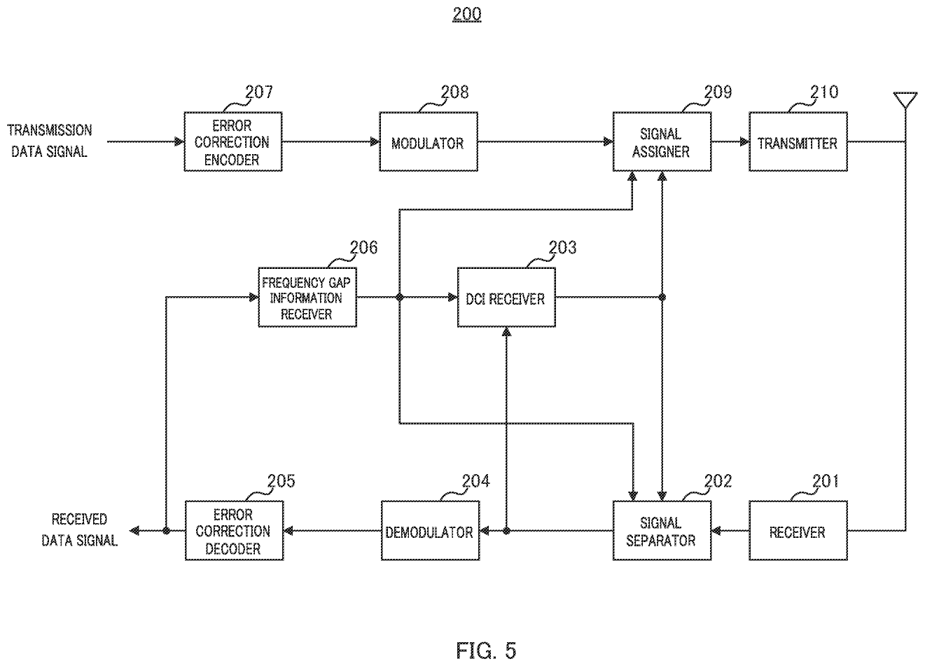

FIG. 5 is a block diagram illustrating a configuration of terminal 200 according to the present embodiment. In FIG. 5, terminal 200 includes receiver 201, signal separator 202, DCI receiver 203, demodulator 204, error correction decoder 205, frequency gap information receiver 206, error correction encoder 207, modulator 208, signal assigner 209, and transmitter 210.

For example, at least one of signal separator 202, DCI receiver 203, demodulator 204, error correction decoder 205, frequency gap information receiver 206, error correction encoder 207, modulator 208, and signal assigner 209, which are illustrated in FIG. 5, may be included in the controller illustrated in FIG. 3. Meanwhile, for example, receiver 201 illustrated in FIG. 5 may be included in the receiver illustrated in FIG. 3.

Receiver 201 receives the received signal via an antenna, performs the reception processing such as the down conversion on the received signal, and then outputs the resultant signal to signal separator 202. The received signal may include, for example, a DL data signal, a DCI, or higher layer signaling.

Signal separator 202 separates a signal on a control channel region (e.g., PDCCH region) from the received signal received from receiver 201 and outputs the resultant signal to DCI receiver 203. In addition, signal separator 202 separates, based on the DL allocation information input from DCI receiver 203, a DL data signal or higher layer signaling from the received signal and outputs the resultant signal to demodulator 204.

Meanwhile, separator 202 need not output a resource component corresponding to the frequency gap to demodulator 204 in a case where, for example, the frequency gap is arranged to (or configured for) a downlink resource based on the information input from DCI receiver 203 or frequency gap information receiver 206.

DCI receiver 203 detects a DCI from the signal input from signal separator 202 to decode and receive the detected DCI. DCI receiver 203, for example, outputs DL allocation information included in the received DCI to signal separator 202 and outputs UL allocation information included in the received DCI to signal assigner 209. Further, DCI receiver 203, for example, determines whether information on a frequency gap is included in the DCI, based on the information input from frequency gap information receiver 206. For example, when the information on the frequency gap is included in the DCI, DCI receiver 203 may output the information on the frequency gap to signal separator 202 and signal assigner 209.

Demodulator 204 demodulates the signal input from signal separator 202 and outputs the demodulated signal to error correction decoder 205.

Error correction decoder 205 decodes the demodulated signal received from demodulator 204, outputs the obtained received data signal, and outputs the obtained higher layer signaling to frequency gap information receiver 206.

Frequency gap information receiver 206 may identify the frequency gap configuration based on higher layer signaling input from error correction decoder 205. Frequency gap information receiver 206 outputs the information on the frequency gap configuration to signal separator 202. DCI receiver 203, or signal assigner 209.

Error correction encoder 207 performs error correction encoding on a transmission data signal (UL data signal) and then outputs the encoded data signal to modulator 208.

Modulator 208 modulates the data signal input from error correction encoder 207 and outputs the modulated data signal to signal assigner 209.

Signal assigner 209 identifies, based on the UL allocation information input from DCI receiver 203, a resource to which the UL data is allocated. Signal assigner 209 then assigns the data signal input from modulator 208 to the identified resource and outputs the data signal to transmitter 210. Meanwhile, signal assigner 209 need not assign an UL signal to a resource corresponding to the frequency gap in a case where, for example, the frequency gap is arranged to (or configured for) an uplink resource based on the information input from frequency gap information receiver 206 or DCI receiver 203.

Transmitter 210 performs the transmission processing such as the up conversion on the signal input from signal assigner 209 and then transmits the resultant signal via an antenna.

### [Operations of Base Station 100 and Terminal 200]

Detailed descriptions will be given of operations of base station 100 and terminal 200 having the above configurations.

For example, when a DL resource and an UL resource are contiguous in frequency domain, interference between them may occur which results in deterioration of the line quality. Note that a boundary of the DL resource and the UL resource in frequency domain is not fixed, but may vary depending on a DL resource amount and an UL resource amount. Further, for example, the entire band may be used for either DL or UL; thus, whether the configuration of a frequency gap is preferable may be variable individually for each symbol or slot.

In the present embodiment, for example, base station 100 may indicate (or instruct), to terminal 200, information on the presence or absence of a frequency gap configuration (frequency gap information) on resource allocation for UL (e.g., Physical Uplink Shared Channel (PUSCH)) or DL (e.g., Physical Downlink Shared Channel (PDSCH)).

The information on the presence or absence of a frequency gap configuration may include, for example, information on at least one of the position of frequency gap and the size of frequency gap, in addition to the presence or absence of a frequency gap configuration.

Arrangement of the frequency gap to the resource allocated to terminal 200 with the frequency gap configuration can reduce interference between DL and UL (e.g., CLI) even when DL and UL are used in the same time resource, for example.

Further, with the indication of the presence or absence of a frequency gap configuration, the configuration of the frequency gap is instructed to terminal 200 at a timing (e.g., symbol or slot) where the interference between DL and UL may occur, whereas non-configuration of the frequency gap is instructed to terminal 200 at a timing (e.g., symbol or slot) where the interference between DL and UL is less likely to occur, for example. Thus, the frequency gap is configured at a preferable timing (e.g., symbol or slot) and is not configured at a timing requiring no configuration, thus improving the utilization efficiency of frequency resources.

In addition, for example, the frequency gap configuration makes it possible to adjust the position or size of frequency gap in accordance with the DL resource amount or the UL resource amount, thereby allowing a frequency gap configuration in accordance with resource allocation to terminal 200.

Further, as described above, for example, the symbol designated as a Flexible symbol can be specified to an UL symbol or a DL symbol, and the interference between DL and UL (e.g., CLI) may occur in the symbol. Therefore, for example, the frequency gap configuration may be applied when the Flexible symbol is included in a resource to which a signal (e.g., PDSCH or PUSCH) is assigned in the resource allocation to terminal 200.

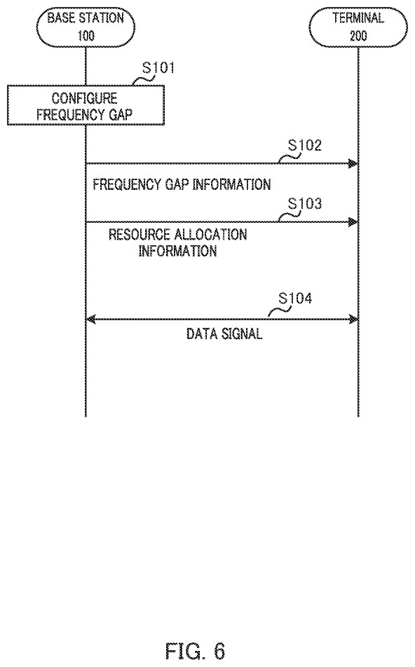

FIG. 6 is a sequence diagram illustrating exemplary operations of base station 100 and terminal 200.

Base station 100 determines a configuration of a frequency gap, for example, on resource allocation for a signal (e.g., PDSCH or PUSCH) to terminal 200 (S101). In the configuration of the frequency gap, base station 100 may determine, for example, the presence or absence of the frequency gap configuration. Additionally, in the configuration of the frequency gap, base station 100 may determine, for example, the position or the size of frequency gap.

Base station 100, for example, indicates, to terminal 200, information on the configuration of the frequency gap (frequency gap information) (S102). Further, base station 100, for example, transmits, to terminal 200, resource allocation information indicating resource allocation to terminal 200 (e.g., at least one of DL allocation information and UL allocation information) (S103).

Note that the frequency gap information in S102 and the resource allocation information in S103 may be indicated to terminal 200 at the same time or may be indicated separately. For example, the frequency gap information and the resource allocation information may be indicated from base station 100 to terminal 200 by a DCI. Alternatively, for example, the frequency gap information may be indicated (or configured) by higher layer signaling (e.g., RRC or MAC) from base station 100 to (on) terminal 200, whereas the resource allocation information may be indicated from base station 100 to terminal 200 by the DCI.

Base station 100 and terminal 200, for example, identify, based on the resource allocation information and the information on the frequency gap configuration, the resource to be allocated to terminal 200 and the frequency gap configuration, and transmit and receive a data signal (e.g., PDSCH or PUSCH) (S104).

Next, operation examples according to the present embodiment will be described.

### Operation Example 1-1

In Operation Example 1-1, for example, base station 100 indicates, to terminal 200 by a DCI to be transmitted through PDCCH, whether to configure a frequency gap on resource allocation for UL (e.g., PUSCH) or DL (e.g., PDSCH).

### Operation Example 1-1-1

In Operation Example 1-1-1, for example, base station 100 indicates, to terminal 200 by the DCI, the information indicating the presence or absence of the frequency gap configuration.

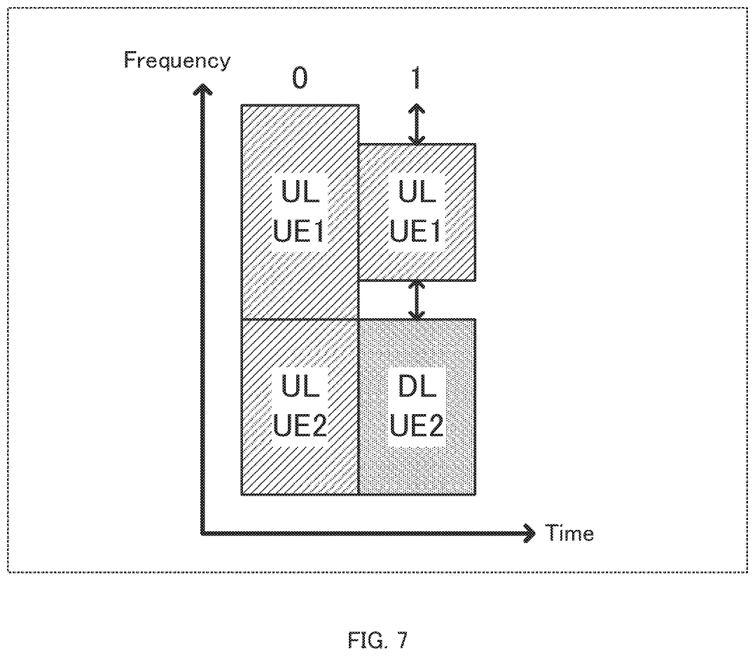

FIG. 7 illustrates an exemplary indication of the frequency gap configuration in Operation Example 1-1-1.

As illustrated in FIG. 7, base station 100 may indicate, to terminal 200, the presence or absence of a frequency gap by one bit (0 or 1) included in a DCI. For example, association between the DCI bit and the frequency gap configuration may be specified as follows:
0: Frequency gap is absent; and
1: Frequency gap is present.

Thus, it is made possible to indicate, from base station 100 to terminal 200, the frequency gap configuration such that a frequency gap is configured when the CLI may occur and no frequency gap is configured when the CLI is less likely to occur, for example.

For example, as illustrated in FIG. 7, in a case where neighboring frequency resources are in different links (e.g., links in different directions), the CLI is likely to occur and a frequency gap may be better configured; hence, base station 100 may indicate, to terminal 200 by the DCI, information corresponding to the presence of the frequency gap (e.g., 1).

On the other hand, for example, as illustrated in FIG. 7, when neighboring frequency resources are in the same link (e.g., link in the same direction), the CLI is less likely to occur and a frequency gap need not be configured; hence, base station 100 may indicate, to terminal 200 by the DCI, information corresponding to the absence of the frequency gap (e.g., 0).

Incidentally, FIG. 7 illustrates, as an example, a case where frequency gaps of the same size are configured at both ends of frequency resource allocated to terminal 200 (e.g., UE 1), but the sizes of frequency gaps may be different from each other. The size of frequency gap may be, for example, previously specified by standards or may be configured for terminal 200 by higher layer signaling (RRC or MAC).

Further, FIG. 7 illustrates, as an example, a case where the frequency gaps are configured at the both ends of the frequency resource allocated to terminal 200 (e.g., UE 1), but a frequency gap may be configured at one end of the frequency resource allocated to terminal 200 (e.g., one end at which CLI may occur).

In one example, the frequency gap may be configured at either a higher end (high frequency side) or a lower end (low frequency side) of the allocated resource in accordance with configuration of a Bandwidth part (BWP) that is configuration of a range within which a resource is allocated to terminal 200.

Further, for example, when the resource for terminal 200 is allocated at the higher end or the lower end of the frequency of the BWP, a frequency gap may be configured at a higher end or a lower end of the BWP. On the other hand, a frequency gap need not be configured when the resource for terminal 200 is allocated to a position that is different from both the higher end and the lower end of the BWP.

### Operation Example 1-1-2

In Operation Example 1-1-2, for example, base station 100 indicates, to terminal 200 by the DCI, the information indicating the presence or absence of a frequency gap configuration and the information indicating the position of frequency gap.

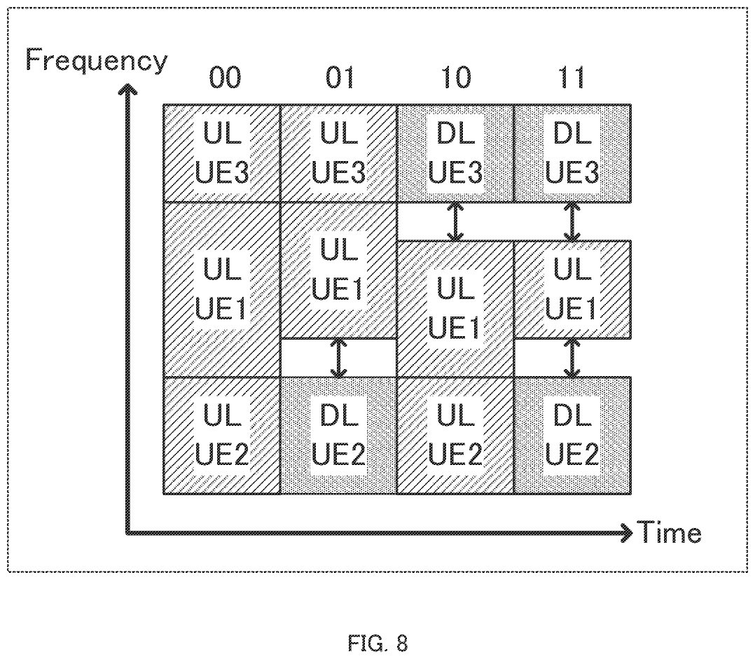

FIG. 8 illustrates an exemplary indication of the frequency gap configuration in Operation Example 1-1-2.

As illustrated in FIG. 8, base station 100 may indicate, to terminal 200, the presence or absence of a frequency gap and the position of frequency gap by two bits (00, 01, 10, or 11) included in a DCI. As the position of frequency gap, for example, any of a lower end in a frequency direction (e.g., end in direction in which PRB (Physical Resource Block) number decreases), a higher end in frequency direction (end in direction in which PRB number increases), and the both ends in the frequency direction may be designated. For example, association between the DCI bit and the frequency gap configuration may be specified as follows:
00: Frequency gap is absent;
01: Frequency gap is present at the lower end in the frequency direction of resource allocation;
10: Frequency gap is present at the higher end in the frequency direction of resource allocation; and
11: Frequency gap is present at the both ends in the frequency direction of resource allocation.

Thus, it is made possible to indicate, from base station 100 to terminal 200, a frequency gap configuration such that a frequency gap is configured in a direction in which a CLI of a frequency resource to which a signal is assigned in resource allocation may occur and no frequency gap is configured in a direction in which the CLI is less likely to occur and no frequency gap is required.

For example, in FIG. 8, in an UL resource for UE 1 to which the DCI bit “01” is indicated, a neighboring resource at a higher end in the frequency direction is an UL resource allocated to UE 3, and a neighboring resource at a lower end in the frequency direction is a DL resource allocated to UE 2. In this case, as illustrated in FIG. 8, taking into account interference to neighboring resources caused by UL transmission performed by UE 1, the interference to the neighboring resource at the higher end in the frequency direction, which is an UL resource, may be small, whereas the interference to the neighboring resource at the lower end in the frequency direction, which is a DL resource, may be large. Thus, in this case, a frequency gap may be configured at a position of the lower end where the DL resource is adjacent to the UL resource for UE 1, whereas a frequency gap need not be configured at a position of the higher end.

Similarly, in FIG. 8, in an UL resource for UE 1 to which the DCI bit “10” is indicated, a neighboring resource at a higher end in the frequency direction is a DL resource allocated to UE 3, and a neighboring resource at a lower end in the frequency direction is an UL resource allocated to UE 2, for example. In this case, as illustrated in FIG. 8, taking into account interference to neighboring resources caused by UL transmission performed by UE 1, the interference to the neighboring resource at the higher end in the frequency direction, which is a DL resource, may be large, whereas the interference to the neighboring resource at the lower end in the frequency direction, which is an UL resource, may be small. Thus, in this case, a frequency gap may be configured at a position of the higher end where the DL resource is adjacent to the UL resource for UE 1, whereas a frequency gap need not be configured at a position of the lower end.

Moreover, in FIG. 8, in an UL resource for UE 1 to which the DCI bit “11” is indicated, a neighboring resource at a higher end in the frequency direction is a DL resource allocated to UE 3, and a neighboring resource at a lower end in the frequency direction is a DL resource allocated to UE 1, for example. In this case, as illustrated in FIG. 8, taking into account interference to neighboring resources caused by UL transmission performed by UE 1, the interference to neighboring resources at the both ends in the frequency direction, which are DL resources, may be large. Thus, in this case, frequency gaps may be configured at positions of the both ends where the DL resources are adjacent to the UL resource for UE 1.

### Operation Example 1-1-3

In Operation Example 1-1-3, for example, base station 100 indicates, to terminal 200 by the DCI, the information indicating the presence or absence of a frequency gap configuration and the information indicating the size of frequency gap.

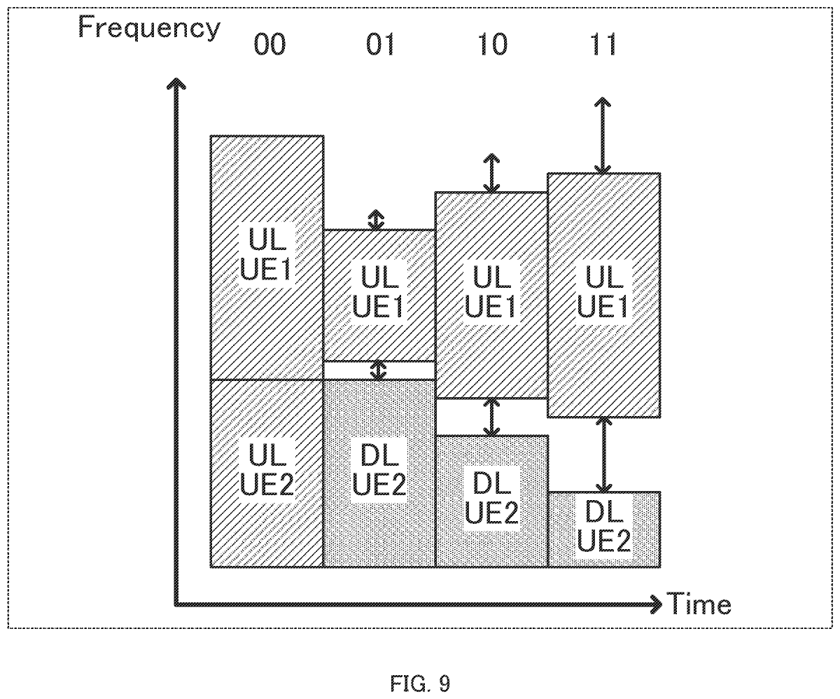

FIG. 9 illustrates an exemplary indication of the frequency gap configuration in Operation Example 1-1-3.

As illustrated in FIG. 9, base station 100 may indicate, to terminal 200, the presence or absence of a frequency gap and the size of frequency gap by two bits (00, 01, 10, or 11) included in a DCI. For example, association between the DCI bit and the frequency gap configuration may be specified as follows:
00: Frequency gap is absent;
01: Frequency gap is present with size of ¼ PRB;
10: Frequency gap is present with size of ½ PRB; and
11: Frequency gap is present with size of 1 PRB.

This allows adjustment of the size of frequency gap. For example, the larger the size of resource allocation is, the greater interference to a neighboring resource is likely to be; hence, as illustrated in FIG. 9, the larger the size of resource allocation to terminal 200 (e.g., UE 1) is, the larger the size of frequency gap may be configured. This makes it possible to reduce the interference to a neighboring resource.

Note that the size of frequency gap is not limited to being based on the size of resource allocation. For example, the larger the transmission power is, the greater interference to a neighboring resource is likely to be: hence, the larger transmission power is, the larger the size of frequency gap may be configured. This makes it possible to reduce the interference to a neighboring resource.

Further, in FIG. 9, a case has been described where the sizes of resources allocated to UE 1 are different from each other, as an example, but the size of frequency gap may be adjusted when the sizes of resources allocated to UE 1 are identical to each other. For example, within each resource allocated to UE 1, the size of frequency gap may be adjustably configured.

Operation Example 1-1 has been described, thus far.

According to Operation Example 1-1, base station 100 can dynamically indicate, to terminal 200 by the DCI, a frequency gap configuration as needed such that a frequency gap is configured when the CLI may occur (e.g., when frequency gap is required) and no frequency gap is configured when the CLI is less likely to occur (e.g., when no frequency gap is required). Meanwhile, terminal 200 can appropriately configure a frequency gap based on the indication from base station 100.

Examples in which no frequency gap is required include the following cases: 1. where DL or UL is aligned between neighboring resources; 2, where resource allocation (e.g., scheduling) performed by base station 100 allows arrangement of frequency gaps in a resource-allocation unit (e.g., gap in PRB or RBG unit); 3, where interference can be reduced between neighboring resources by using an omnidirectional antenna; or 4. where a resource can be separated by separation in a spatial axis, such as Multiple Input Multiple Output (MIMO). A reason of non-configuration of a frequency gap may be indicated or may not be indicated to terminal 200.

### Supplemental Notes of Operation Example 1-1

In Operation Example 1-1 described above, a case has been described where a frequency gap is configured for an UL resource, as illustrated in FIGS. 7, 8, and 9, but the present disclosure is not limited to this case, and a frequency gap may be configured for a DL resource.

Further, the DCI may be, for example, DCI format 0_0, 0_1, or 0_2 that is a control signal for allocating an UL resource, DCI format 1_0, 1_1, or 1_2 that is a control signal for allocating a DL resource, or a newly specified (or defined, added) DCI format.

Additionally, the DCI is not limited to a DCI for allocating a resource for each UE individually, and may be, for example, a DCI that can be received by a plurality of UEs, such as a DCI referred to as a Group Common DCI.

Further, whether to add a bit corresponding to the above-described frequency gap configuration may be configured to be variable depending on the DCI format. For example, DCI format 0_0 and DCI format 1_0 may not include a bit corresponding to the above-described frequency gap configuration, whereas a DCI format different from both DCI format 0_0 and DCI format 1_0 may include the bit corresponding to the above-described frequency gap configuration.

In addition, the size of frequency gap may be previously specified by standards or may be indicated to terminal 200 by higher layer signaling (RRC or MAC).

Further, the size of frequency gap may be different between at an higher end and at a lower end of a resource allocated to terminal 200.

Further, the size of frequency gap may be configured to be variable in accordance with a resource amount allocated to terminal 200. For example, the greater the resource amount allocated to terminal 200 is, the larger the frequency gap may be configured, whereas the smaller the resource amount allocated to terminal 200 is, the smaller the frequency gap may be configured.

Further, the size of frequency gap may be configured to be variable in accordance with, for example, the size of BWP (number of PRBs) or the size of Resource Block Group (RBG) determined from the size of BWP. For example, the larger the size of BWP or RBG is, the larger frequency gap may be configured, whereas the smaller the size of BWP or RBG is, the smaller frequency gap may be configured.

Besides, for example, Operation Example 1-1-2 and Operation Example 1-1-3 may be applied in combination. For example, the information on the frequency gap configuration may include the information on the presence or absence of a frequency gap configuration, on the position of frequency gap, and on the size of frequency gap. By way of example, base station 100 may indicate, to terminal 200, a DCI that includes a bit associated with the presence or absence of a frequency gap configuration, the position of frequency gap, and the size of frequency gap.

### Operation Example 1-2

In Operation Example 1-2, for example, base station 100 indicates, to terminal 200 by a higher layer, whether to configure a frequency gap on resource allocation for UL (e.g., PUSCH) or DL (e.g., PDSCH). The higher layer may include, for example, RRC or MAC.

Operation Example 1-2 can reduce the number of DCI bits as compared with Operation Example 1-1.

### Operation Example 1-2-1

In Operation Example 1-2-1, whether a frequency gap is configured is variable depending on a CORESET at which terminal 200 has detected a DCI. For example, the CORESET configured for terminal 200 by higher layer signaling may be associated with the information on the presence or absence of a frequency gap.

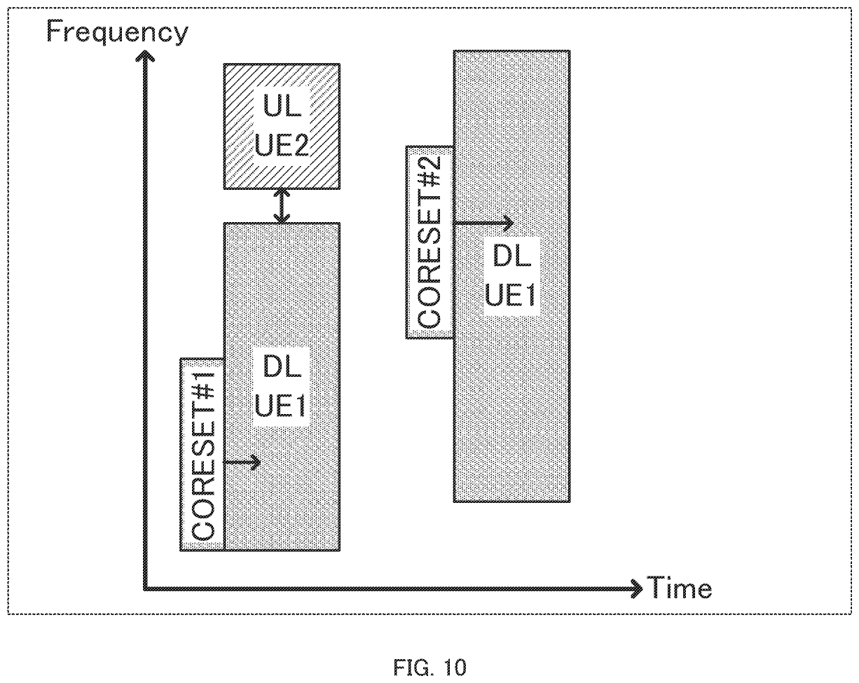

FIG. 10 illustrates an exemplary indication of a frequency gap configuration in Operation Example 1-2-1.

Here, a DCI is transmitted through PDCCH. In addition, time- and frequency-domain resources for PDCCH are configured by a CORESET. Further, a candidate for resource detection in the CORESET is configured by a Search Space. The CORESET and the Search Space may be configured for terminal 200 by, for example, a higher layer such as RRC.

In FIG. 10, for example, when terminal 200 (e.g., UE 1) detects a DCI in CORESET #1, a frequency gap may be configured for a resource allocated by the DCI (in FIG. 10, DL resource). On the other hand, in FIG. 10, for example, when terminal 200 (e.g., UE 1) detects a DCI in CORESET #2, a frequency gap need not be arranged for a resource allocated by the DCI. Thus, switching the CORESET in which the DCI is transmitted allows switching the arrangement of a frequency gap.

Incidentally, in FIG. 10, the association between a CORESET and a frequency gap has been described, but the present disclosure is not limited to this, and a Search Space and a frequency gap may be associated with each other, for example. By way of example, terminal 200 may determine the presence or absence of a frequency gap configuration, based on a Search Space at which a DCI has been detected.

For example, a plurality of CORESETs and Search Spaces that are configured by RRC can be configured for terminal 200. In one example, when a CORESET or a Search Space is configured, a frequency gap configuration may be configured to be variable depending on a CORESET number or a Search Space number.

Besides, for example, a frequency gap configuration may be associated with a DCI format (control signal format). For example, a DCI format to be monitored by terminal 200 is configured by RRC. Therefore, terminal 200 may determine the presence or absence of a frequency gap configuration, based on the DCI format of the detected DCI, for example. By way of example, DCI format 0_0 and DCI format 1_0 may be associated with the absence of a frequency gap, and DCI format 0_1 and DCI format 1_1 may be associated with the presence of a frequency gap.

### Operation Example 1-2-2

In Operation Example 1-2-2, whether a frequency gap is configured is variable depending on a BWP configured for terminal 200. For example, the BWP configured for terminal 200 by higher layer signaling may be associated with the information on the presence or absence of a frequency gap.

NR includes, for example, a provision that a DL BWP and an UL BWP in an active state is to be one each per frequency carrier. Moreover, a provision is also included that center frequencies of a DL BWP and an UL BWP in the active state at the same time are to be aligned.

In Operation Example 1-2-2, the position of frequency gap may be individually specified for each BWP.

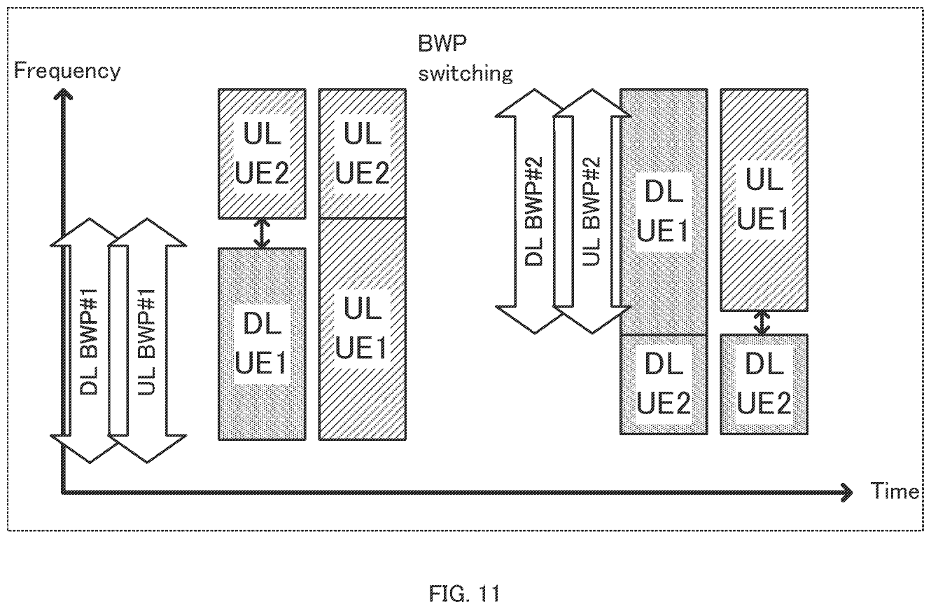

FIG. 11 illustrates an exemplary indication of a frequency gap configuration in Operation Example 1-2-2.

As illustrated in FIG. 11, in DL BWP #1, a frequency gap is configured at a higher end of a frequency resource allocated to terminal 200 (e.g., UE 1), whereas a frequency gap need not be configured in UL BWP #1. This configuration is an effective configuration when a resource adjacent to DL BWP #1 is assumed to be used for UL (in FIG. 11, UL resource for UE 2), for example.

Further, as illustrated in FIG. 11, in UL BWP #2, a frequency gap is configured at a lower end of a frequency resource allocated to terminal 200 (e.g., UE 1), whereas a frequency gap need not be configured in DL BWP #2. This configuration is an effective configuration when a resource adjacent to UL BWP #2 is assumed to be used for DL (in FIG. 11, DL resource for UE 2), for example.

For example, a frequency region configuration of the BWP may be configured so as not to include an upper end or lower end of the frequency region, taking into account a frequency gap. In such a configuration, however, due to the restriction in NR that the center frequencies of a DL BWP and an UL BWP in the active state at the same time are to be aligned, when one (DL or UL) BWP is configured with a narrower end frequency region, taking into account the frequency gap, the other (DL or UL) BWP is configured with the narrower end frequency region likewise. In contrast, in FIG. 11, even when a frequency gap is configured for either DL or UL BWP, no effect is brought on the frequency region of the other BWP, thus making it possible to suppress a reduction in the frequency-utilization efficiency.

In FIG. 11, a case has been described where a frequency gap is configured at one end of a DL BWP or an UL BWP, but a frequency gap may be configured at both ends of the DL BWP and the UL BWP. This configuration is effective when, for example, a higher end and a lower end of the BWP are used for different links.

Further, in FIG. 11, a case has been described where a frequency gap is configured at either of a DL BWP or an UL BWP, but a frequency gap may be configured at both of the DL BWP and the UL BWP.

Besides, a position to which a frequency gap is configured is not limited to an end of a DL BWP or an UL BWP, and a frequency gap may be configured to an end of a resource allocated to terminal 200 of the BWP, for example.

Operation Example 1-2 has been described, thus far.

### Variations of Operation Example 1-1 and Operation Example 1-2

Hereinafter, descriptions will be given of Variation 1-1, Variation 1-2, and Variation 1-3 that are applicable to each of Operation Example 1-1 and Operation Example 1-2.

### Variation 1-1

In Variation 1-1, for example, the configuration of the presence or absence of a frequency gap may be applied to an entirety of a resource allocated to a signal of terminal 200.

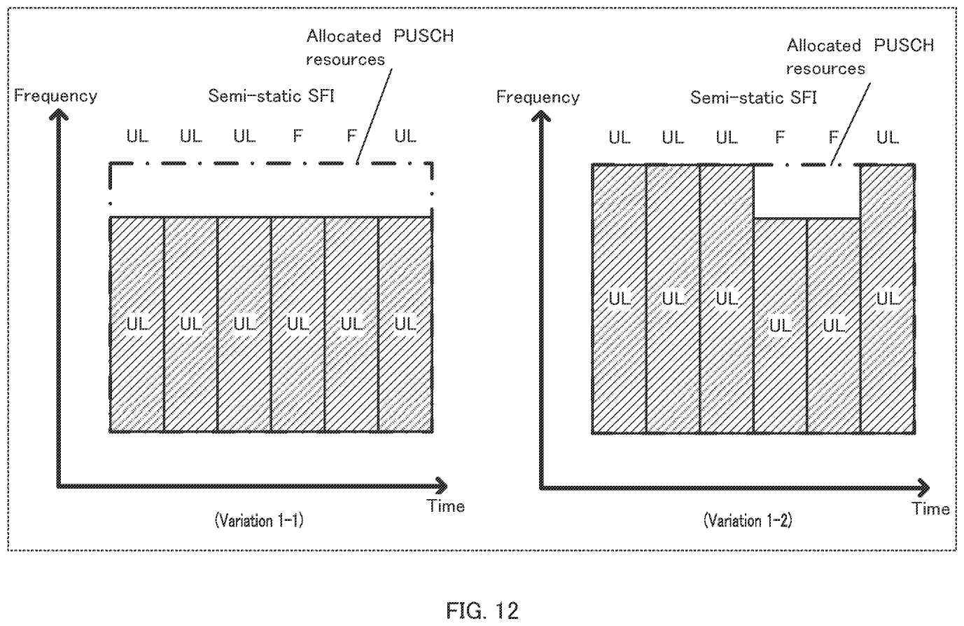

For example, as illustrated in FIG. 12, when a frequency gap configuration is specified and resources allocated to terminal 200 include symbols (e.g., Flexible symbols) designated as “F (Flexible)” by a semi-static SFI, base station 100 and terminal 200 may configure (or arrange) frequency gaps for (to) all the symbols allocated to terminal 200. It is desirable, herein, to make transmission power constant between symbols. In

Variation 1-1, for example, the available number of subcarriers can be configured to be the same between the symbols of resources allocated to terminal 200. Thus, when the number of subcarriers used for transmission is the same between the symbols, terminal 200 can perform transmission with a constant transmission power per resource element (RE).

In NR, PRB is composed of 12 subcarriers, and the resource of 1 symbol×1 subcarrier is called an RE.

### Variation 1-2

In Variation 1-2, for example, the configuration of the presence or absence of a frequency gap may be applied to a Flexible symbol of a resource allocated to a signal of terminal 200.

For example, as illustrated in FIG. 12, when a frequency gap configuration is specified and resources allocated to terminal 200 include symbols (e.g., Flexible symbols) designated as “F (Flexible)” by a semi-static SFI, base station 100 and terminal 200 may configure frequency gaps for the symbols designated as F (Flexible) by the semi-static SFI and need not configure frequency gaps for the other symbols.

In this manner, a symbol for which “(Uplink) UL” or “(Downlink) DL” is specified by the semi-static SFI can be used for Uplink or Downlink even when the symbol is a subcarrier corresponding to a frequency gap, thus suppressing a reduction in the available number of REs.

In Variation 1-2, in order to make transmission power constant between symbols, for example, the transmission power per RE is changed between a symbol to which a frequency gap is configured and a symbol to which no frequency gap is configured, thus, the transmission power per symbol may be configured to be constant between the symbols.

For example, when base station 100 and terminal 200 share a resource amount of a frequency gap, terminal 200 can calculate, for a DL signal, a power ratio between symbols from the number of REs to which the frequency gap is configured, without indication of a transmission-power ratio between a symbol with no frequency gap and a symbol with the frequency gap.

In FIG. 12, as an example, a case has been described where a frequency gap configuration is determined in units of symbols, but the present disclosure is not limited to this case, and a frequency gap configuration may be determined in units of slots when a plurality of slots are allocated to terminal 200 at the same time, for example.

Variation 1-2 has been described, thus far.

Next, a description will be given of a calculation method of a transport block size (TBS) when a frequency gap is configured in Variation 1-1 and Variation 1-2. For example, the number of REs used for the calculation of a TBS is determined by the following Equation (see, e.g., NPL 2):

[1]

$${N}_{RE}^{′} = {N}_{sc}^{RB} \cdot {N}_{symb}^{sh} - {N}_{DMRS}^{PRB} - {N}_{oh}^{PRB} . \qquad ( Equation 1 )$$

In Equation 1. N_{SC}^{RB} indicates the number of subcarriers, e.g., may be N_{SC}^{RB}=12. N_{symb}^{sh} indicates the number of symbols, N_{DMRS}^{PRB} indicates an overhead amount with respect to DMRS, and Nₒₕ^{PRB} indicates an overhead amount indicated to terminal 200 by a higher layer.

In the present embodiment, the following three options are given as for calculation of N′_{RE} and resource arrangement (mapping).

### <Option 1>

In Option 1, N′_{RE} may be calculated assuming a resource area allocated to terminal 200 and using the same equation as in a case where no frequency gap is configured. In Option 1, a resource for terminal 200 may be allocated assuming that no resource for the frequency gap is present.

In Option 1. N′_{RE} is calculated independently the presence or absence of a frequency gap, thus simplifying the calculation of N′_{RE}. Further, when no frequency gap is configured at the time of retransmission, an appropriate TBS is configured.

### <Option 2>

In Option 2, a value, which is obtained from subtracting an area where a frequency gap is arranged from a resource area allocated to terminal 200, may be used for N′_{RE}.

Assuming that the number of REs to which a frequency gap is arranged is “Nₒₕ^{gap},” N′_{RE} may be calculated by, for example, the following Equation (e.g., see NPL 2): [2]

$${N}_{RE}^{′} = {N}_{sc}^{RB} \cdot {N}_{symb}^{sh} - {N}_{DMRS}^{PRB} - {N}_{oh}^{PRB} - {N}_{oh}^{gap} . \qquad ( Equation 2 )$$

In Option 2, a resource for terminal 200 may be allocated, assuming that no resource with a frequency gap is present.

In Option 2, the number of REs is calculated taking into account the presence or absence of a frequency gap, thereby making it easier to select a TBS appropriately.

### <Option 3>

In Option 3, as in Option 1, N′_{RE} may be calculated using the same equation to a case where no frequency gap is configured.

In Option 3, unlike Option 1, for example, in resource mapping, a resource allocated to an RE with a frequency gap may be deleted (e.g., punctured) while a resource for terminal 200 is mapped as in the case where no frequency gap is configured.

Option 3 allows the same resource mapping between a case with a frequency gap and a case without a frequency gap.

### [Variation 1-3]

In Variation 1-3, a description will be given of a case where a repetitive transmission (repetition) of PUSCH or PDSCH, or Transport block processing over multi-slot (TBoMS) is applied. In NR, the repetition and the TBoMS are studied for UL, but the present scheme is not limited to UL.

In NR, for example, two PUSCH repetition schemes are specified as the repetitive transmission. The first scheme is slot-by-slot Repetition where the same time resource allocation is applied over consecutive slots. The slot-by-slot Repetition is also called “PUSCH repetition Type A,” In PUSCH repetition Type A, base station 100 may indicate, to terminal 200, time resource allocation in a slot and the number of repetition slots. Here, the number of repetition slots may be a value to be counted based on the consecutive slots. The second scheme is a method of repeatedly transmitting one or a plurality PUSCHs in one slot. This scheme is also called “PUSCH repetition Type B,” In PUSCH repetition Type B, base station 100 may indicate, to terminal 200, a time-domain resource for the first (or initial) PUSCH transmission and the number of repetitions. In PUSCH repetition Type B. in time-domain resource allocation for the second and subsequent PUSCH transmissions, symbols may be assigned, which are consecutive to and in number identical to the previous PUSCH transmission.

TBoMS is a method, which is discussed in NR Rel. 17, of transmitting PUSCH using multiple slots. For TBoMS, the following methods have been discussed: a method of determining a TBS based on a resource amount, the number of symbols, or the number of resource elements of the multiple slots used for transmission of PUSCH; or a method of determining a TBS by multiplying the TBS calculated based on the resource amount in slot-by-slot or allocated for an initial PUSCH transmission in Repetition by a scaling factor greater than one, for example. The transmission of PUSCH transmitted in multiple slots based on the TBS calculated by these methods is referred to as “TBoMS PUSCH” transmission.

In Variation 1-3, for example, when a frequency gap configuration is specified and any of the following resource units in resources allocated to terminal 200 includes a symbol designated as “F (Flexible)” by a semi-static SFI, base station 100 and terminal 200 may configure a frequency gap in the resource unit.
1. All Symbol Units for Transmitting and Receiving PUSCH or PDSCH

When a symbol in which PUSCH or PDSCH is transmitted and received includes a symbol designated as F (Flexible) by the semi-static SFI, a frequency gap may be configured for a PUSCH resource or PDSCH resource.
2. Slot or Subframe Units

When a slot or subframe includes a symbol designated as F (Flexible) by the semi-static SFI, a frequency gap may be configured in units of slots or subframes.
3. Mini-slot unit

A mini-slot represents a resource that is shorter than a slot length allocated in a slot. For example, when the mini-slot includes a symbol designated as F (Flexible) by the semi-static SFI, a frequency gap may be configured in units of mini-slots.
4. Transmission Occasion Units

A transmission occasion is, for example, a resource unit corresponding to one repetition when PUSCH is repeatedly transmitted in PUSCH repetition Type B. For example, when the transmission occasion includes a symbol designated as F (Flexible) by the semi-static SFI, a frequency gap may be configured in units of Transmission occasions.
5. Single TBoMS units

A single TBoMS is, for example, a resource unit when transmission is performed in a plurality of resources in TBoMS. For example, when the Single TBoMS includes a symbol designated as F (Flexible) by the semi-static SFI, a frequency gap may be configured in units of Single TBoMSs.
6. Configured Time Domain Window (TDW) Units

A Configured TDW is, for example, a unit for configuration of a constant transmission power when a signal is transmitted with consecutive resources in the repetitive transmission or TBoMS. For example, the Configured TDW includes a symbol designated as F (Flexible) by the semi-static SFI, a frequency gap may be configured in units of Configured TDWs.
7. Actual Configured Time Domain Window (TDW) Units

An Actual Configured TDW is, for example, a resource unit with which consecutive transmission is actually performed, among resources which is configured by the Configured TDW and for which a constant transmission power is configured when a signal is transmitted with consecutive resources in the repetitive transmission or TBoMS. For example, when the Actual Configured TDW includes a symbol designated as F (Flexible) by the semi-static SFI, a frequency gap may be configured in units of Actual Configured TDWs.

Besides, as in Variation 1-1 and Variation 1-2, the three options for calculation of N′_{RE} and resource mapping may be applied to Variation 1-3. Note that Option 1 and Option 3 may be the same as the above-described methods. Option 2 (referred to as Option 2′) in Variation 1-3 will be described below.

### <Option 2′>

In Option 2′, in the case of repetitive transmission (repetition), when a frequency gap is arranged in an initial repetition resource (e.g., 1^{st} Transmission occasion) of the repetitive transmission, a value obtained from subtracting an area where the frequency gap is arranged from a resource area allocated to terminal 200 may be used for N′_{RE}. Assuming that the number of REs to which a frequency gap is arranged is “Nₒₕ^{gap},” N′_{RE} may be calculated by, for example, the following Equation:

[3]

$${N}_{RE}^{′} = {N}_{sc}^{RB} \cdot {N}_{symb}^{sh} - {N}_{DMRS}^{PRB} - {N}_{oh}^{PRB} - {N}_{oh}^{gap} . \qquad ( Equation 2 )$$

Meanwhile, in the case of TBoMS, when resources of (the number of slots)×(the number of symbols per slot) are used and when a frequency gap is arranged for an initial slot as a reference, a value obtained from subtracting an area where a frequency gap is arranged from a resource area allocated to terminal 200 may be used for N′_{RE}. On the other hand, in TBoMS, when no frequency gap is arranged for the initial slot as the reference, N′_{RE} may be calculated assuming the resource area allocated to terminal 200 even when a frequency gap is arranged for a slot behind. In other words, in calculation of N′_{RE}, it is unnecessary to subtract an area where a frequency gap is arranged from a resource area allocated to terminal 200.

Besides, for the resource mapping in Option 2′, a resource for terminal 200 may be allocated assuming that no resource with a frequency gap is present.

In Option 2′, the number of REs is calculated taking into account the presence or absence of a frequency gap, thereby making it easier to select a TBS appropriately.

The operation examples have been each described, thus far.

In this manner described above, in the present embodiment, base station 100 determines the information on the presence or absence of a frequency gap configuration on resource allocation for a signal and then indicates the determined information to terminal 200. Meanwhile, terminal 200 receives the information on the presence or absence of the frequency gap configuration on the resource allocation for the signal and then determines the frequency gap configuration, based on the received information.

According to the present embodiment, a frequency gap configuration makes it possible to suppress interference between a DL resource and an UL resource even when they are adjacent to each other in frequency domain, thereby improving the line quality.

Further, for example, even when the boundary between a DL resource and an UL resource in frequency domain varies, a frequency gap configuration in accordance with the variation of the boundary or a resource amount makes it possible to suppress the interference between DL and UL.

Besides, for example, base station 100 can individually determine a frequency gap configuration for each time resource, such as a symbol or a slot, in accordance with the resource allocation (e.g., allocation of symbol or slot) to terminal 200. Therefore, according to the present embodiment, for example, a frequency gap can be configured, for a resource allocated to terminal 200, to be variable in accordance with the type of neighboring resource or the type of symbol that is assigned.

In the manner described above, according to the present embodiment, it is possible to suppress signal interference in radio communication

Note that, in the present embodiment, the units of frequency gaps may be units of PRBs, units of subcarriers, or other units of frequency resources.

Further, for example, Operation Example 1-1 and Operation Example 1-2 may be applied in combination. For example, a frequency resource area (e.g., CORESET or Search Space) to which a frequency gap can be configured may be configured for terminal 200 by the higher layer as in Operation Example 1-2, and a frequency gap configuration in each time resource unit (e.g., symbol or slot) may be indicated to terminal 200 by a DCI as in Operation Example 1-1.

### Embodiment 2

In Embodiment 1, a method of suppressing interference (e.g., CLI) by a frequency gap configuration has been described. In the present embodiment, a description will be given of a method of suppressing interference by transmission power control (e.g., reduction in transmission power for signal).

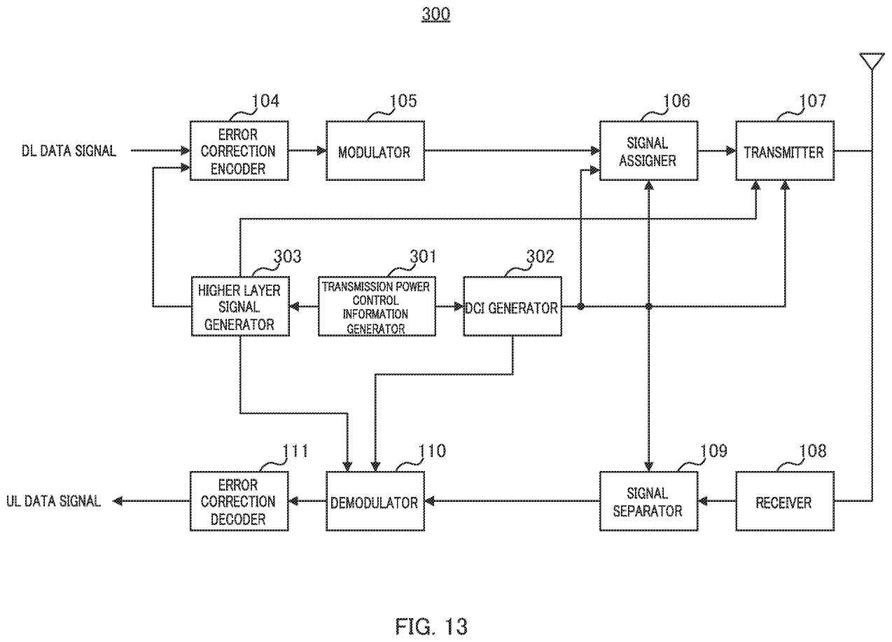

FIG. 13 is a block diagram illustrating a configuration of base station 300 according to the present embodiment. In FIG. 13, components that perform the substantially same operation as those in Embodiment 1 are given the same reference numerals, and the descriptions thereof are omitted.

Transmission-power control information generator 301, for example, determines whether to configure (or limit) a reduction in the maximum transmission power or transmission power of a signal (e.g., PDSCH or PUSCH) in resource allocation to terminal 400 and determines, based on a determination result, configuration information on configuration of transmission power control (e.g., referred to as transmission-power control information).

The transmission-power control information may include, for example, at least information on the presence or absence of the configuration of the transmission power reduction (hereinafter may also be referred to as transmission-power reduction configuration). The transmission-power control information may also include, for example, information on an amount of the reduction (hereinafter may also be referred to as “reduction amount”) in the transmission power control.

Transmission-power control information generator 301 outputs the generated transmission-power control information to higher layer signal generator 303. In addition, transmission-power control information generator 301 outputs the transmission-power control information to DCI generator 302 when indicating the transmission-power control information to terminal 400 by a DCI, for example.

DCI generator 302 generates, for example, at least one of a DCI that is a control signal for allocating DL data and a DCI that is a control signal for allocating UL data. Further, for example, DCI generator 302 may add, to the DCI, the transmission-power control information that is input from transmission-power control information generator 301.

DCI generator 302 may, for example, output the generated DCI to signal assigner 106 as transmission data. For example, DCI generator 302 may output, to signal assigner 106, the DCI for DL allocation as the control signal for allocating DL. Further, DCI generator 302 may output the transmission-power control information, to transmitter 107, when a reduction in the maximum transmission power or transmission power of a signal (e.g., PDSCH) is configured.

Further, DCI generator 302 may, for example, output, to signal separator 109, the DCI for UL allocation as the control signal that indicates the position to which the UL data is allocated. Besides, DCI generator 302 may output the transmission-power control information, to transmitter 107 and demodulator 110, when it is assumed that transmission power or received power of a signal (e.g., PDSCH or PUSCH) varies between symbols, for example.

Higher layer signal generator 303, for example, generates, based on the transmission-power control information input from transmission-power control information generator 301, a higher layer signal (e.g., signal of RRC or MAC) on the transmission power control (e.g., reduction in transmission power (hereinafter may also be referred to as “transmission power reduction”)) and then outputs the generated signal to error correction encoder 104. Besides, higher layer signal generator 303 may output the transmission-power control information, to transmitter 107 and demodulator 110, when it is assumed that transmission power or received power of a signal (e.g., PDSCH or PUSCH) varies between symbols, for example.

In addition to performing the same operation as in Embodiment 1, when the transmission-power control information is input from DCI generator 302 or higher layer signal generator 303, transmitter 107 may configure (e.g., reduce) transmission power of a corresponding symbol based on the transmission-power control information, for example.

In addition to performing the same operation as in Embodiment 1, when the transmission-power control information is input from DCI generator 302 or higher layer signal generator 303, demodulator 110 may perform demodulation processing based on the transmission-power control information, assuming a reduction in received power of the corresponding symbol, for example.

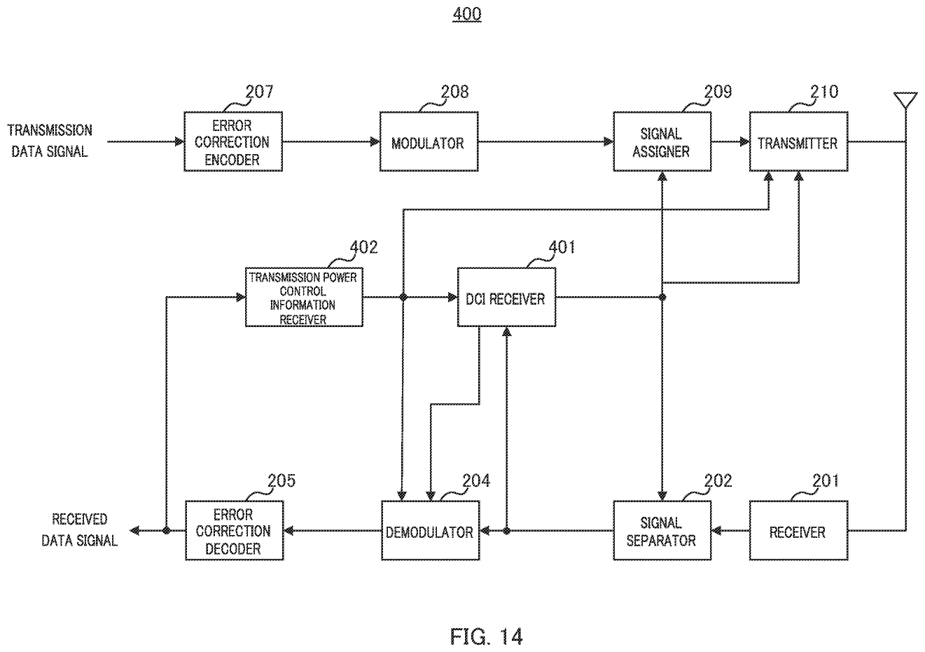

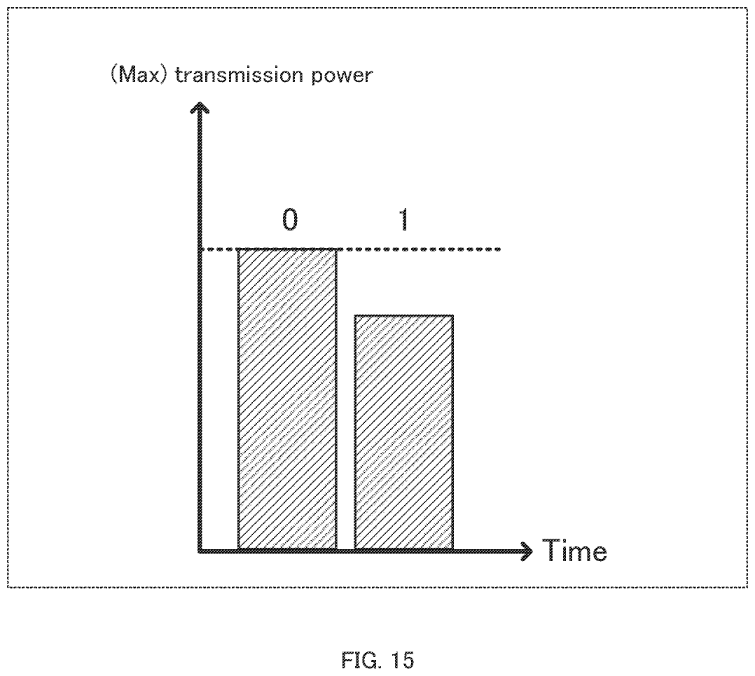

FIG. 14 is a block diagram illustrating a configuration of terminal 400 according to the present embodiment. In FIG. 14, components that perform the substantially same operation as those in Embodiment 1 are given the same reference numerals, and the descriptions thereof are omitted.

DCI receiver 401 detects a DCI from the signal input from signal separator 202 to decode and receive the detected DCI. DCI receiver 401, for example, outputs DL allocation information included in the received DCI to signal separator 202 and outputs UL allocation information included in the received DCI to signal assigner 209. Further, DCI receiver 401, for example, determines whether information on configuration of a transmission power reduction is included in the DCI based on the information input from transmission-power control information receiver 402. For example, when the DCI includes the information on the transmission-power reduction configuration, DCI receiver 401 may output, to transmitter 210 and demodulator 204, the information on the transmission-power reduction configuration.

Transmission-power control information receiver 402 may identify the configuration of the transmission power reduction, based on higher layer signaling input from error correction decoder 205. Transmission-power control information receiver 402 outputs the identified information on the configuration of the transmission power reduction to DCI receiver 401, transmitter 210, and demodulator 204.

In addition to performing the same operation as in Embodiment 1, when the transmission-power control information is input from DCI receiver 401 or transmission-power control information receiver 402, demodulator 204 may perform demodulation processing based on the transmission-power control information, assuming a reduction in received power of a corresponding symbol, for example.

In addition to performing the same operation as in Embodiment 1, when the transmission-power control information is input from DCI receiver 401 or transmission-power control information receiver 402, transmitter 210 may configure (e.g., reduce) transmission power of a corresponding symbol based on the transmission-power control information, for example.

### [Operations of Base Station 300 and Terminal 400]

Detailed descriptions will be given of operations of base station 300 and terminal 400 having the above configurations.

For example, when a DL resource and an UL resource are arranged to the same time resource, interference may occur between resources identical to each other in frequency domain or resources close to each other in frequency domain, which results in deterioration of the line quality. Additionally, interference may occur when both DL and UL are used between cells or base stations.

In the present embodiment, for example, base station 300 may indicate, to terminal 400, information on the presence or absence of a configuration of a reduction in transmission power (e.g., maximum transmission power or transmission power), on resource allocation for UL (e.g., PUSCH) or DL (e.g., PDSCH).

The information on the presence or absence of the transmission-power reduction configuration may include, for example, information on a reduction amount of transmission power, in addition to the presence or absence of the transmission power reduction.

The transmission-power reduction configuration can reduce interference between DL and UL (e.g., CLI) even when a DL resource and an UL resource are mapped in the same time resource.

As an example, in UL, transmission power of PUSCH may be determined according to the following equation (see, e.g., NPL 1):

[4]

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} . \qquad ( Equation 4 )$$

P_{CMAX,b,f,c}(i) indicates the maximum transmission power per carrier of terminal 400. The maximum transmission power may be individually configured for each terminal 400. Further, in the present embodiment, in a reduction in (limitation on) transmission power, a reduction amount of transmission power may be adjusted by reducing P_{O_PUSCH,b,f,c}(j) that is a target-received power or reducing a that is a compensation factor of a path loss, instead of reducing the maximum transmission power.

Meanwhile, in DL (e.g., PDSCH), for example, it is assumed that transmission power is constant between consecutive symbols in the same resource, and terminal 400 performs reception processing of PDSCH based on this assumption. For example, when the transmission power reduction of PDSCH is specified from base station 300, terminal 400 may perform the reception processing (e.g., demodulation processing), assuming that, in a corresponding symbol, the transmission power is lower than that of the other symbols. Note that this method may be applied to UL.

The indication of the presence or absence of a transmission-power reduction configuration makes it possible to, for example, reduce the amount of interference given to a DL signal when terminal 400 at a cell edge transmits an UL signal with an increased transmission power. In addition, for example, it is also made possible to reduce the amount of interference given by a DL signal transmitted by base station 300 to reception of an UL signal performed by another base station 300.

Further, as described above, for example, the symbol designated as a Flexible symbol can be specified to an UL symbol or a DL symbol, and the interference between DL and UL (e.g., CLI) may occur in the symbol. Therefore, for example, the transmission-power reduction configuration may be applied when a Flexible symbol is included in a resource allocated to a signal (PDSCH or PUSCH) in resource allocation to terminal 400.

Next, operation examples according to the present embodiment will be described.

### Operation Example 2-1

In Operation Example 2-1, for example, base station 300 indicates, to terminal 400 by a DCI transmitted through PDCCH, whether to configure, on resource allocation for UL (e.g., PUSCH) or DL (e.g., PDSCH), a limitation on the maximum value of transmission power (maximum transmission power) or the transmission power.

### Operation Example 2-1-1

In Operation information 2-1-1, for example, base station 300 indicates, to terminal 400 by a DCI, information on the presence or absence of a reduction in the maximum transmission power or transmission power.

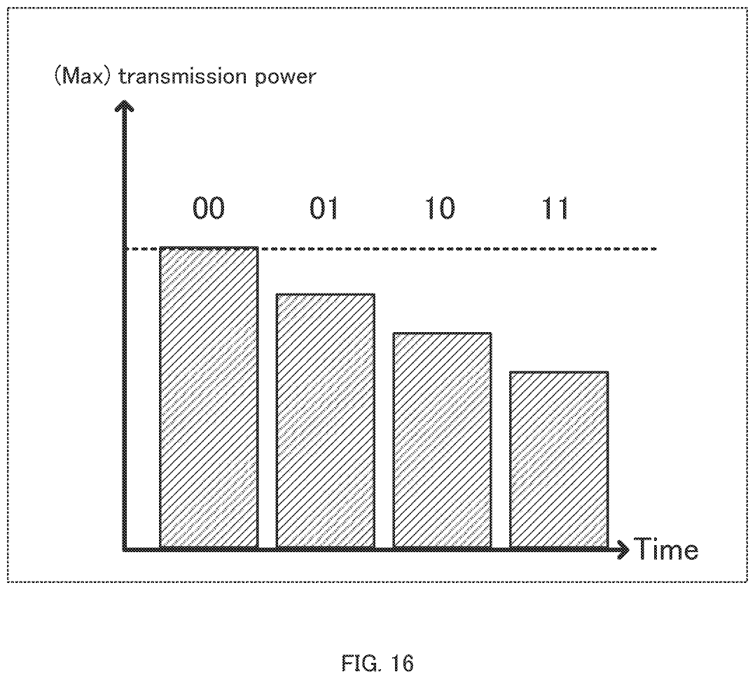

FIG. 15 illustrates an exemplary indication of a configuration of the maximum transmission power or transmission power in Operation Example 2-1-1.

As illustrated in FIG. 15, base station 300 may indicate, to terminal 400, the presence or absence of a reduction in the maximum transmission power by one bit (0 or 1) included in a DCI. For example, association between the DCI bit and a configuration of the maximum transmission power may be specified as follows:
0: Reduction in (limitation on) maximum transmission power is absent; and
1: Reduction in (limitation on) maximum transmission power is present.

Similarly, as illustrated in FIG. 15, base station 300 may indicate, to terminal 400, the presence or absence of a reduction in transmission power by one bit (0 or 1) included in the DCI. For example, association between the DCI bit and a configuration of the transmission power may be specified as follows:
0: Reduction in (limitation on) transmission power is absent; and
1: Reduction in (limitation on) transmission power is present.

Thus, it is made possible to indicate, from base station 300 to terminal 400, a transmission-power control configuration such that a reduction in the maximum transmission power or transmission power is configured for terminal 400 when CLI may occur and no reduction in the maximum transmission power or transmission power is configured for terminal 400 when the CLI is less likely to occur, for example.

For example, in a case where neighboring frequency resources are in different links (e.g., links in different directions), the CLI is likely to occur and transmission power may be better reduced: hence, base station 300 may indicate, to terminal 400 by a DCI, information corresponding to the presence of the reduction in (limitation on) the maximum transmission power or transmission power (e.g., 1).

On the other hand, for example, when neighboring frequency resources are in the same link (e.g., link in the same direction), the CLI is less likely to occur and transmission power need not be reduced; hence, base station 300 may indicate, to terminal 400 by a DCI, information corresponding to the absence of the reduction in (limitation on) the maximum transmission power or transmission power (e.g., 0).

Note that the reduction amount of the maximum transmission power or transmission power may be previously specified by standards or may be indicated to terminal 400 by higher layer signaling (RRC or MAC).

For example, different values may be set for the reduction amount of the maximum transmission power or transmission power, in accordance with configuration of a BWP that is a configuration of a range within which a resource is allocated to terminal 400.

### Operation Example 2-1-2

In Operation Example 2-1-2, for example, base station 300 indicates, to terminal 400 by a DCI, information on the presence or absence of a reduction in the maximum transmission power or transmission power and information on a reduction amount of the maximum transmission power or transmission power.

FIG. 16 illustrates an exemplary indication of a configuration of the maximum transmission power or transmission power in Operation Example 2-1-2.

As illustrated in FIG. 16, base station 300 may indicate, to terminal 400, the presence or absence of a reduction in the maximum transmission power and a reduction amount of the maximum transmission power by two bits (00, 01, 10, or 11) included in a DCI. For example, association between the DCI bit and the configuration of the maximum transmission power may be specified as follows:

00: Reduction in (limitation on) maximum transmission power is absent:

01: Reduction in (limitation on) maximum transmission power is present of −1 dB;

10: Reduction in (limitation on) maximum transmission power is present of −3 dB; and
11: Reduction in (limitation on) maximum transmission power is present of −6 dB.

Similarly, as illustrated in FIG. 16, base station 300 may indicate, to terminal 400, the presence or absence of a reduction in transmission power and a reduction amount of the transmission power by two bits (00, 01, 10, or 11) included in a DCI. For example, association between the DCI bit and the configuration of the transmission power may be specified as follows:
00: Reduction in (limitation on) transmission power is absent;
01: Reduction in (limitation on) transmission power is present of −1 dB;
10: Reduction in (limitation on) transmission power is present of −3 dB; and
11: Reduction in (limitation on) transmission power is present of −6 dB.

This allows adjustment of the reduction amount of maximum transmission power or the transmission power. For example, the larger the size of resource allocation is, the greater interference to a neighboring resource is likely to be; hence, the larger the size of resource allocation to terminal 400 is, the larger the reduction amount of the maximum transmission power or transmission power may be configured. This makes it possible to reduce the interference to a neighboring resource.

Note that the above-mentioned reduction amount of the maximum transmission power or transmission power is merely exemplary and may be other values. Additionally, the reduction amount of the maximum transmission power or transmission power may be configured for terminal 400 by higher layer signaling (e.g., RRC or MAC).

Operation Example 2-1 has been described, thus far.

According to Operation Example 2-1, base station 300 can dynamically indicate, to terminal 400 by a DCI, a configuration of the maximum transmission power or transmission power as needed such that a reduction in the maximum transmission power or transmission power is configured when CLI may occur (e.g., when transmission power reduction is required) and no reduction in the maximum transmission power or transmission power is configured when the CLI is less likely to occur (e.g., when no transmission power reduction is required). Meanwhile, terminal 400 can appropriately configure the maximum transmission power or transmission power based on the indication from base station 300.

Examples in which no reduction in the maximum transmission power or transmission power is required include the following cases: 1, where DL or UL is aligned between neighboring resources: 2, where interference between allocated resources is assumed to be less (e.g., interference less than threshold) due to resource allocation (e.g., scheduling) performed by base station 300; 3. where a frequency gap can be configured in units of PRBs or RBGs: 4, where a frequency gap is configured by Embodiment 1; 5. where interference between neighboring resources can be reduced by using an omnidirectional antenna; or 6, where a resource can be separated by separation in a spatial axis, such as MIMO. A reason of non-configuration of a reduction in the maximum transmission power or transmission power may be indicated or may not be indicated to terminal 400.

### Supplemental Notes of Operation Example 2-1

In Operation Example 2-1 described above, a description has been given of a reduction in transmission power in UL as illustrated in FIGS. 15 and 16, but the present disclosure is not limited to this, and a reduction in transmission power in DL may be configured. When the reduction in transmission power in DL is present, terminal 400 may perform reception processing (e.g., demodulation processing), assuming that received power varies between a corresponding symbol and a neighboring symbols

Further, the DCI may be, for example, DCI format 0_0, 0_1, or 0_2 that is a control signal for allocating an UL resource, DCI format 1_0, 1_1, or 1_2 that is a control signal for allocating a DL resource, or a newly specified (or defined, added) DCI format.

Additionally, the DCI is not limited to a DCI for allocating a resource for each UE individually, and may be, for example, a DCI that can be received by a plurality of UEs, such as a DCI referred to as a Group Common DCI.

Further, whether to add a bit corresponding to the above-described transmission power configuration may be configured to be variable depending on the DCI format. For example, DCI format 0_0 and DCI format 1_0 may not include a bit corresponding to the above-described transmission power configuration, whereas a DCI format different from both DCI format 0_0 and DCI format 1_0 may include the bit corresponding to the above-described transmission power configuration.

In addition, a reduction amount of the maximum transmission power or transmission power may be previously specified by standards or may be indicated to terminal 400 by higher layer signaling (RRC or MAC).

Further, a reduction amount of the maximum transmission power or transmission power may be configured to be variable in accordance with a resource amount allocated to terminal 400. For example, the greater the resource amount allocated to terminal 400 is, the larger the reduction amount may be configured, whereas the smaller the resource amount allocated to terminal 400 is, the smaller the reduction amount may be configured.

### Operation Example 2-2

In Operation Example 2-2, for example, base station 300 indicates, to terminal 400 by a higher layer, the presence or absence of a reduction in maximum transmission power or transmission power on resource allocation for UL (e.g., PUSCH) or DL (e.g., PDSCH). The higher layer may include, for example, RRC or MAC.

Operation Example 2-2 can reduce the number of DCI bits as compared with Operation Example 2-1.

### Operation Example 2-2-1

In Operation 2-2-1, whether the maximum transmission power or transmission power is reduced is variable depending on a CORESET at which terminal 400 has detected a DCI. For example, the CORESET configured for terminal 400 by higher layer signaling may be associated the information on the presence or absence of a reduction in the maximum transmission power or transmission power.

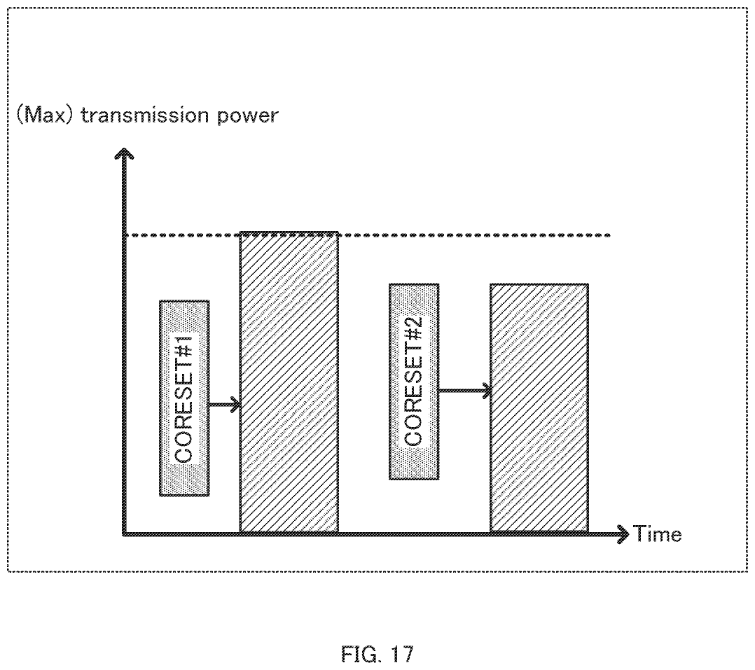

FIG. 17 illustrates an exemplary indication of a configuration of the maximum transmission power or transmission power in Operation Example 2-2-1.

Here, a DCI is transmitted through PDCCH. In addition, time- and frequency-domain resources for PDCCH are configured by a CORESET. Further, a candidate for resource detection in the CORESET is configured by a Search Space. The CORESET and the Search Space may be configured for terminal 400 by, for example, a higher layer such as RRC.

In FIG. 17, for example, when terminal 400 detects a DCI in CORESET #1, a reduction in (limitation on) the maximum transmission power or transmission power need not be configured for a resource allocated by the DCI. On the other hand, in FIG. 17, for example, when terminal 400 detects a DCI in CORESET #2, a reduction in the maximum transmission power or transmission power may be configured for a resource allocated by the DCI. Thus, switching the CORESET in which the DCI is transmitted allows switching the presence or absence of a reduction in the maximum transmission power or transmission power.

Note that a reduction in the maximum transmission power or transmission power may be configured for either DL or UL, and may be configured for both DL and UL.

Incidentally, in FIG. 17, the association between a CORESET and a configuration of the maximum transmission power or transmission power has been described, but the present disclosure is not limited to this, and a Search Space and a configuration of the maximum transmission power or transmission power may be associated with each other, for example. By way of example, terminal 400 may determine the presence or absence of a reduction in the maximum transmission power or transmission power, based on a Search Space at which a DCI has been detected.

For example, a plurality of CORESETs and Search Spaces that are configured by RRC can be configured for terminal 400. In one example, when a CORESET or a Search Space is configured, a configuration of a limitation on the maximum transmission power or transmission power may be configured to be variable depending on a CORESET number or a Search Space number.

Besides, for example, a configuration of a limitation on the maximum transmission power or transmission power may be associated with a DCI format. For example, a DCI format to be monitored by terminal 400 is configured by RRC. Therefore, terminal 400 may determine the presence or absence of a limitation on the maximum transmission power or transmission power, based on the DCI format of the detected DCI, for example. By way of example, DCI format 0_0 and DCI format 1_0 may be associated with the absence of a limitation on the maximum transmission power or transmission power, and DCI format 0_1 and DCI format 1_1 may be associated with the presence of a limitation on the maximum transmission power or transmission power.

### Operation Example 2-2-2

In Operation 2-2-2, whether the maximum transmission power or transmission power is reduced is variable depending on a BWP configured for terminal 400. For example, a BWP configured for terminal 400 by higher layer signaling may be associated the information on the presence or absence of a reduction in the maximum transmission power or transmission power.

NR includes, for example, a provision that a DL BWP and an UL BWP in an active state is to be one each per frequency carrier.

In Operation Example 2-2-2, the presence or absence of a reduction in the maximum transmission power or transmission power may be individually specified for each BWP.

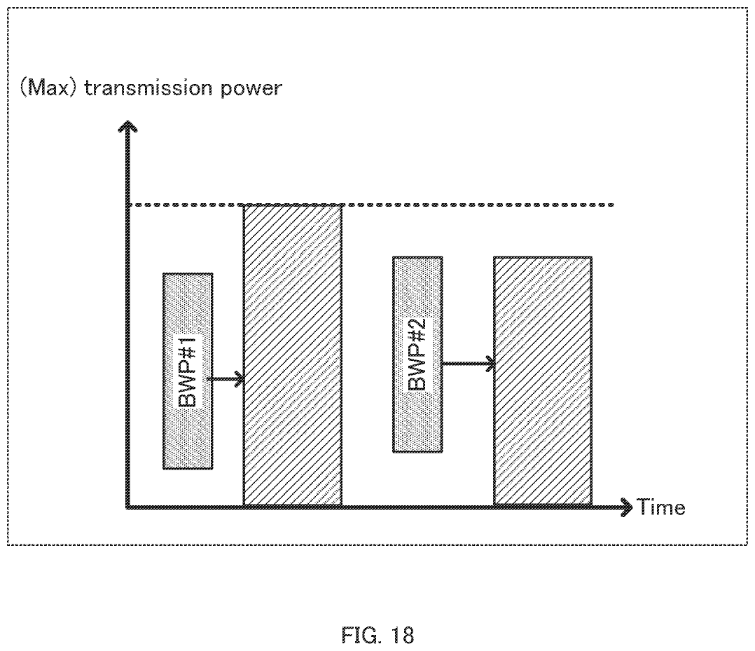

FIG. 18 illustrates an exemplary indication of a configuration of the maximum transmission power or transmission power in Operation Example 2-2-2.

As illustrated in FIG. 18, the presence of a reduction in (limitation on) the maximum transmission power or transmission power may be configured in BWP #1, whereas, in BWP #2, the absence of a reduction in (limitation on) the maximum transmission power or transmission power) may be configured.

For example, a BWP allows terminal 400 to change a PRB to be used, so that a neighboring cell to which interference is caused may vary depending on the BWP. In such a case, a method of individually specifying the presence or absence of a reduction in the maximum transmission power or transmission power for each BWP is effective.

Note that a reduction in the maximum transmission power or transmission power may be configured for either a DL BWP or an UL BWP, and may be configured for both the DL BWP and the UL BWP.

Operation Example 2-2 has been described, thus far.

### Variations of Operation Example 2-1 and Operation Example 2-2

Hereinafter, descriptions will be given of Variation 2-1, Variation 2-2, and Variation 2-3 that are applicable to each of Operation Example 2-1 and Operation Example 2-2.

### Variation 2-1

In Variation 2-1, for example, a configuration of the presence or absence of a reduction in the maximum transmission power or transmission power may be applied to an entirety of a resource allocated to a signal of terminal 400.

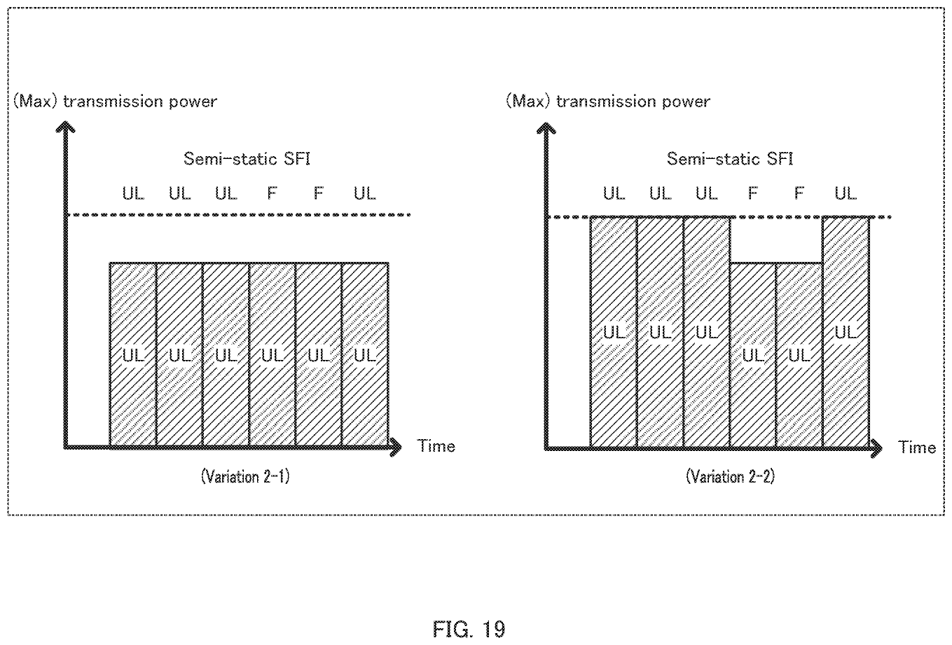

For example, as illustrated in FIG. 19, when a reduction in the maximum transmission power or transmission power is specified and resources allocated to terminal 400 include symbols (e.g., Flexible symbols) designated as “F (Flexible)” by a semi-static SFI, base station 300 and terminal 400 may reduce the maximum transmission power or transmission power for all the symbols allocated to terminal 400.

It is desirable, herein, to make transmission power constant between symbols. In Variation 2-1, for example, transmission can be performed with constant transmission power between the symbols of resources allocated to terminal 400.

### Variation 2-2

In Variation 2-2, for example, a configuration of the presence or absence of a reduction in the maximum transmission power or transmission power may be applied to a Flexible symbol in a resource allocated to a signal of terminal 400.

For example, as illustrated in FIG. 19, when a reduction in the maximum transmission power or transmission power is specified and resources allocated to terminal 400 include symbols (e.g., Flexible symbols) designated as “F (Flexible)” by a semi-static SFI, base station 300 and terminal 400 may configure the presence of a reduction in (limitation on) the maximum transmission power or transmission power in the symbol designated as F (Flexible) by the semi-static SFI and configure the absence of a reduction in (limitation on) the maximum transmission power or transmission power in the other symbols.

In this manner, in a symbol for which “(Uplink) UL” or “(Downlink) DL” is specified by the semi-static SFI, transmission and reception of a signal with an unlimited transmission power can be performed.

For example, when a power amplitude includes information such as high modulation levels (e.g., 16QAM, 64QAM, and 256QAM), base station 300 and terminal 400 may share a difference in transmission power between a symbol with a limited transmission power and a symbol with an unlimited transmission power. Base station 300 and terminal 400 may perform reception processing (e.g., demodulation processing) take into consideration a difference amount.

In FIG. 19, as an example, a case has been described where a configuration of the maximum transmission power or transmission power is determined in units of symbols, but the present disclosure is not limited to this case, and a configuration of the maximum transmission power or transmission power may be determined in units of slots when a plurality of slots are allocated to terminal 400 at the same time, for example.

### Variation 2-3

In Variation 2-3, a description will be given of a case where a repetitive transmission (repetition) of PUSCH or PDSCH, or TBoMS is applied. In NR, the repetition and the TBoMS are studied for UL, but the present scheme is not limited to UL.

In Variation 2-3, for example, when a reduction in the maximum transmission power or transmission power is specified and any of the following resource units in resources allocated to terminal 400 includes a symbol designated as “F (Flexible)” by a semi-static SFI, base station 300 and terminal 400 may reduce the maximum transmission power or transmission power in the resource unit.

### 1. All Symbol Units for Transmitting and Receiving PUSCH or PDSCH

When a symbol in which PUSCH or PDSCH is transmitted and received includes a symbol designated as F (Flexible) by the semi-static SFI, the maximum transmission power or transmission power may be reduced in a symbol in which PUSCH or PDSCH is transmitted.

### 2. Slot or Subframe Units

When a slot or subframe includes a symbol designated as F (Flexible) by the semi-static SFI, the maximum transmission power or transmission power of PUSCH or PDSCH may be reduced in units of slots or subframes.

### 3. Mini-Slot Units

A mini-slot represents a resource that is shorter than a slot length allocated in a slot. For example, when the mini-slot includes a symbol designated as F (Flexible) by the semi-static SFI, the maximum transmission power or transmission power of PUSCH or PDSCH may be reduced in units of mini-slots.

### 4. Transmission Occasion Units

A transmission occasion is, for example, a resource unit for one repetition when PUSCH is repeatedly transmitted in PUSCH repetition Type B. For example, when the transmission occasion includes a symbol designated as F (Flexible) by the semi-static SFI, the maximum transmission power or transmission power of PUSCH or PDSCH may be reduced in units of Transmission occasions.

### 5. Single TBoMS Units

A single TBoMS is, for example, a resource unit when transmission is performed in a plurality of resources in TBoMS. For example, when the Single TBoMS includes a symbol designated as F (Flexible) by the semi-static SFI, the maximum transmission power or transmission power of PUSCH or PDSCH may be reduced in units of Single TBoMSs.

### 6. Configured Time Domain Window (TDW) Units

A Configured TDW is, for example, a unit for configuration of a constant transmission power when a signal is transmitted with consecutive resources in the repetitive transmission or TBoMS. For example, the Configured TDW includes a symbol designated as F (Flexible) by the semi-static SFI, the maximum transmission power or transmission power of PUSCH or PDSCH may be reduced in units of Configured TDWs.

### 7. Actual Configured Time Domain Window (TDW) Units

An Actual Configured TDW is, for example, a resource unit with which consecutive transmission is actually performed, among resources which is configured by the Configured TDW and for which a constant transmission power is configured when a signal is transmitted with consecutive resources in the repetitive transmission or TBoMS. For example, when the Actual Configured TDW includes a symbol designated as F (Flexible) by the semi-static SFI, the maximum transmission power or transmission power of PUSCH or PDSCH may be reduced in units of Actual Configured TDWs.

The operation examples have been each described, thus far.

In this manner described above, in the present embodiment, base station 300 determines the information on the presence or absence of a transmission-power reduction configuration on resource allocation for a signal and then indicates the determined information to terminal 400. Meanwhile, terminal 400 receives the information on the presence or absence of the transmission-power reduction configuration on the resource allocation for the signal and then determines the transmission-power reduction configuration, based on the received information.

According to the present embodiment, the transmission power reduction makes it possible to suppress interference between resources identical to each other in frequency domain or resources close to each other in frequency domain even when a DL resource and an UL resource are mapped in the same time resource frequency domain, thereby improving the line quality.

Further, the reduction in transmission power can suppress interference between cells or base stations 300 even when both DL and UL are used between cells or base stations 300, for example.

### Embodiment 3

A base station and a terminal according to the present embodiment may be, for example, the same as the base station and the terminal according to Embodiment 1 or Embodiment 2.

For example, in the present embodiment, a Flexible symbol may have a plurality of types. By way of example, a “DL symbol,” an “UL symbol,” a “Flexible symbol 1,” and a “Flexible symbol 2” may be defined as types of symbols specified by an SFI.

Flexible symbol 1 may be, for example, a symbol assuming the same operation as the Flexible symbol specified in NR Rel. 15 to Rel. 17.

Flexible symbol 1 may be a newly specified (added) symbol that is different from Flexible symbol 1.

As Flexible symbol 2, the following may be assumed.

For example, the symbol designated as a Flexible symbol in Embodiment 1 or Embodiment 2 may be replaced with Flexible symbol 2. For example, a resource (e.g., symbol or slot) to which a frequency gap configuration or a reduction in the maximum transmission power or transmission power is applied may be determined based on Flexible symbol 2.

For example, a frequency gap configuration or a reduction in the maximum transmission power or transmission power may be applied to a resource including Flexible symbol 2. On the other hand, for example, a frequency gap configuration or a reduction in the maximum transmission power or transmission power need not be applied to a resource including no Flexible symbol 2 but including Flexible symbol 1.

Information on Flexible symbol 2 may be included in an SFI transmitted through, for example, a control signal such as a System Information Block (SIB), terminal-specific RRC, or the group common DCI.

Alternatively, the information on Flexible symbol 2 may be indicated only by, for example, the UE-specific RRC or the group common DCI. For example, since an SIB can be commonly received by a UE supporting Rel. 15 to Rel. 17, a symbol designated as Flexible symbol 1 may be configured to Flexible symbol 2 by the UE-specific RRC or the group common DCI, without causing the information on Flexible symbol 2 to be included in the SIB.

Further, for example, as a configuration of a Channel State Information-Reference Signal (CSI-RS), a Periodic CSI-RS and a semi-persistent CSI-RS cannot be configured, but an Aperiodic CSI-RS can be configured for (can be mapped to) Flexible symbol 2.

Alternatively, as a configuration of CSI-RS, any of the Periodic CSI-RS, the semi-persistent CSI-RS, and the Aperiodic CSI-RS can be configured for (can be mapped to) Flexible symbol 2. In this manner, it is possible to increase the number of symbols to which the CSI-RS can be mapped.

Further, when a resource is allocated to Flexible symbol 2, the minimum time from reception of PDSCH by a terminal (e.g., terminal 200 or terminal 400) to transmission of a response signal (e.g., HARQ-ACK) in UL may be configured to be longer than that for a case where the resource is allocated to a symbol that is different from and other than Flexible symbol 2. This is to ensure a processing time for eliminating cross link interference when a resource is allocated to Flexible symbol 2.

For example, in NPL 2, the shortest time, T_{proc,1}, from reception of the last symbol of PDSCH by a terminal to transmission of HARQ-ACK information is defined by the following equation:

[5]

$${T}_{proc , 1} = ( {N}_{1} + {d}_{1 , 1} + {d}_{2} ) ( 2048 + 144 ) \cdot κ {2}^{- μ} \cdot {T}_{c} + {T}_{ext} . \qquad ( Equation 5 )$$

In the present embodiment, for example, the shortest time, T_{proc,1}, from reception of the last symbol of PDSCH by a terminal to transmission of HARQ-ACK information may be defined by the following equation with a newly added parameter of “da” to Equation 5:

[6]

$${T}_{proc , 1} = ( {N}_{1} + {d}_{1 , 1} + {d}_{2} + {d}_{3} ) ( 2048 + 144 ) \cdot κ {2}^{- μ} \cdot {T}_{C} + {T}_{ext} . \qquad ( Equation 6 )$$

The parameter da may be, for example, a parameter based on the processing time for eliminating the cross link interference. For example, the larger the value of d₃ is, the longer the processing time for a case where a resource is allocated to Flexible symbol 2 (e.g., when elimination processing of cross link interference is performed).

The embodiments of the present disclosure have been each described, thus far.

### Other Embodiments

1. In the above embodiments, a case has been described where PDSCH or PUSCH is assumed, but the present disclosure is not limited to this case, and a non-limiting example of the present disclosure may be applied to, for example, a Physical Sidelink Shared Channel (PSSCH) for Sidelink communication.

When a non-limiting example of the present disclosure is applied to PSSCH, a frequency gap configuration or a transmission-power control configuration may be indicated by a 1st stage sidelink control information (1st SCI) mapped to PSCCH, for example. Further, for example, for a frequency gap configuration or a transmission-power control configuration, the presence or absence of the application may be determined based on configurations of other Sidelink symbols, instead of determination based on whether a Flexible symbol is included in a resource allocated to terminal.

2. Embodiment 1 and Embodiment 2 may be applied in combination.

For example, a DCI may include an indication bit (e.g., one bit) for configuration of a frequency gap in Embodiment 1 and an indication bit (e.g., one bit) for configuration of transmission power control in Embodiment 2.

Alternatively, for example, with the higher layer configuration, an indication of a DCI bit and a combination of indications in Embodiment 1 and Embodiment 2 (e.g., candidate for combination of frequency gap configuration and transmission-power control configuration) may be configured (associated) in advance.

Further, for example, the smaller the size of frequency gap in Embodiment 1 is, the greater the reduction amount of transmission power in Embodiment 2 may be configured, whereas the larger the size of frequency gap in Embodiment 1 is, the smaller the reduction amount of transmission power in Embodiment 2 may be configured. For example, the larger the size of frequency gap is, the more the interference amount can be reduced, thereby suppressing a reduction in transmission power.

3. In the above embodiments, a case has been described where a configuration of a frequency gap and a configuration of a transmission power are applied when, for example, a Flexible symbol (or Flexible symbol 2) is included in a resource for PUSCH or PDSCH allocated to the terminal, but the present disclosure is not limited to this case.

For example, the frequency gap configuration and the transmission power configuration may be applied to a Flexible symbol (or Flexible symbol 2) that is configured by the SIB or the UE-specific RRC. For example, the frequency gap configuration and the transmission power configuration may be applied even when the Flexible symbol configured by the SIB or RRC is specified to an UL symbol or a DL symbol by an SFI of DCI format 2_0.

Further, for example, the frequency gap configuration and the transmission power configuration may be applied to a Flexible symbol (or Flexible symbol 2) that is configured by the SIB. For example, the frequency gap configuration and the transmission power configuration may be applied even when the Flexible symbol configured by the SIB is specified to an UL symbol or a DL symbol by the UE-specific RRC or an SFI of DCI format 2_0.

4. A case has been described where a non-limiting example of the present disclosure is applied when a Flexible symbol is included, but the present disclosure is not limited to this case. A non-limiting example of the present disclosure may be applied to, for example, a symbol with a different type from the Flexible symbol, for which interference between different links (e.g., CLI) may occur.

Further, the values used in a non-limiting example of the present disclosure, such as the number of DCI bits (e.g., the number of candidates for configurations) that indicates a configuration of a frequency gap or transmission power reduction, the size of frequency gap, a reduction amount of the maximum transmission power or transmission power, the number of symbols, the number of slots, and the like, are merely exemplary and are not limited to these.

### (Supplement)

Information indicating whether terminal 200 and/or terminal 400 support(s) the functions, operations, or processing described in the above embodiment may be transmitted (or indicated) from terminal 200 and/or terminal 400 to base station 100 and/or base station 300 as capability information or capability parameter(s) of terminals 200 and 400, for example.

The capability information may include an information element (IE) individually indicating whether terminal 200 and/or terminal 400 support(s) at least one of the functions, operations, and processing described in the above embodiment. Alternatively, the capability information may include an information element indicating whether terminal 200 and/or terminal 400 support(s) a combination of any two or more of the functions, operations, and processing described in the above embodiment.

Base station 100 and/or base station 300, for example, may determine (decide or assume), based on the capability information received from terminal 200 and/or terminal 400, the functions, operations, and processing supported (or unsupported) by terminal 200 and/or terminal 400 that has/have transmitted the capability information. Base station 100 and/or base station 300 may perform operations, processing, or control in accordance with a determination result based on the capability information. For example, base station 100 and/or base station 300 may configure a frequency gap or control transmission power, based on the capability information received from terminal 200 and/or terminal 400.

Note that the fact that terminal 200 and/or terminal 400 do not support some of the functions, operations, or processing described in the above embodiment may be interpreted as limitation on such functions, operations, or processing in terminal 200 and/or terminal 400. For example, information or a request related to such limitation may be indicated to base station 100 and/or base station 300.

Information on the capability or limitation of terminal 200 and/or terminal 400 may be, for example, defined by standards, or implicitly indicated to base station 100 and/or base station 300 in association with information known in base station 100 and/or base station 300 or information transmitted to base station 100 and/or base station 300.

### (Control Signal)

In the present disclosure, a downlink control signal (or downlink control information) related to an exemplary embodiment of the present disclosure may be a signal (or information) transmitted through a Physical Downlink Control Channel (PDCCH) of the physical layer, for example, or may be a signal (or information) transmitted through a Medium Access Control Control Element (MAC CE) or the Radio Resource Control (RRC) of a higher layer. Further, the signal (or information) is not limited to that notified by the downlink control signal, but may be predefined in the specifications (or standard) or may be pre-configured for the base station and the terminal.

In the present disclosure, an uplink control signal (or uplink control information) relating to an exemplary embodiment of the present disclosure may be, for example, a signal (or information) transmitted through a PUCCH of the physical layer or a signal (or information) transmitted through the MAC CE or RRC of the higher layer. Further, the signal (or information) is not limited to that notified by the uplink control signal, and may be predefined in the specifications (or standard) or may be pre-configured for the base station and the terminal. The uplink control signal may be replaced with, for example, uplink control information (UCI), 1st stage sidelink control information (SCI), or 2nd stage SCI.

### (Base Station)

In an exemplary embodiment of the present disclosure, the base station may be a Transmission Reception Point (TRP), a cluster head, an access point, a Remote Radio Head (RRH), an eNodeB (eNB), a gNodeB (gNB), a Base Station (BS), a Base Transceiver Station (BTS), a master device, a gateway, or the like. Further, in sidelink communication, a terminal may play a role of the base station. Alternatively, the base station may be replaced with a relay device that relays communication between a higher node and a terminal, or may be replaced with a roadside device.

### (Uplink/Downlink/Sidelink)

An exemplary embodiment of the present disclosure may be applied to, for example, any of uplink, downlink, and sidelink. For example, an exemplary embodiment of the present disclosure may be applied to a Physical Uplink Shared Channel (PUSCH), a Physical Uplink Control Channel (PUCCH), and a Physical Random Access Channel (PRACH) in the uplink, a Physical Downlink Shared Channel (PDSCH), PDCCH or a Physical Broadcast Channel (PBCH) in the downlink, or a Physical Sidelink Shared Channel (PSSCH), a Physical Sidelink Control Channel (PSCCH), a Physical Sidelink Broadcast Channel (PSBCH) in the sidelink.

Note that PDCCH, PDSCH, PUSCH and PUCCH are examples of a downlink control channel, a downlink data channel, an uplink data channel, and an uplink control channel, respectively. PSCCH and PSSCH are examples of a sidelink control channel and a sidelink data channel. Further, PBCH and PSBCH are examples of broadcast channels, and PRACH is an example of a random access channel.

### (Data Channel/Control Channel)

An exemplary embodiment of the present disclosure may be applied to, for example, either of a data channel or a control channel. For example, a channel in an exemplary embodiment of the present disclosure may be replaced with a data channel including any of PDSCH, PUSCH, and PSSCH or a control channel including any of PDCCH. PUCCH, PBCH, PSCCH, and PSBCH.

### (Reference Signal)

In an exemplary embodiment of the present disclosure, a reference signal is a signal known to both of a base station and a mobile station, for example, and may also be referred to as a Reference Signal (RS) or a pilot signal. The reference signal may be any of a Demodulation Reference Signal (DMRS), a Channel State Information-Reference Signal (CSI-RS), a Tracking Reference Signal (TRS), a Phase Tracking Reference Signal (PTRS), a Cell-specific Reference Signal (CRS), or a Sounding Reference Signal (SRS).

### (Time Intervals)

In an exemplary embodiment of the present disclosure, the units of time resources are not limited to one or a combination of slots and symbols, but may be, for example, time resource units such as frames, superframes, subframes, slots, time slot, subslots, minislots, or symbols, Orthogonal Frequency Division Multiplexing (OFDM) symbols, Single Carrier-Frequency Division Multiplexing (SC-FDMA) symbols, or other time resource units. The number of symbols included in one slot is not limited to any number of symbols exemplified in the above-described embodiments, and may be another number of symbols.

### (Frequency Band)

An exemplary embodiment of the present disclosure may be applied to either a licensed band or an unlicensed band.

### (Communication)

An exemplary embodiment of the present disclosure may be applied to any of communication between a base station and a terminal (Uu-link communication), communication between a terminal and a terminal (Sidelink communication), and Vehicle to Everything (V2X) communication. For example, a channel in an exemplary embodiment of the present disclosure may be replaced with any of PSCCH, PSSCH, Physical Sidelink Feedback Channel (PSFCH), PSBCH, PDCCH, PUCCH, PDSCH, PUSCH, and PBCH.

In addition, an exemplary embodiment of the present disclosure may be applied to either of a terrestrial network or a network other than the terrestrial network (Non-Terrestrial Network (NTN)) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### (Antenna Ports)

In an exemplary embodiment of the present disclosure, an antenna port refers to a logical antenna (antenna group) formed of one physical antennas or a plurality of physical antennas. For example, the antenna port does not necessarily refer to one physical antenna, and may refer to an array antenna formed of multiple antennas or the like. For example, it is not defined how many physical antennas from the antenna port, and instead, the antenna port is defined as the minimum unit through which a terminal is allowed to transmit a reference signal. The antenna port may also be defined as the minimum unit for multiplication of a precoding vector weighting.

### <5G NR System Architecture and Protocol Stack>

3GPP has been working on the next release for the 5th generation cellular technology (simply called “5G”), including the development of a new radio access technology (NR) operating in frequencies ranging up to 100 GHz. The first version of the 5G standard was completed at the end of 2017, which allows proceeding to 5G NR standard-compliant trials and commercial deployments of terminals (e.g., smartphones).

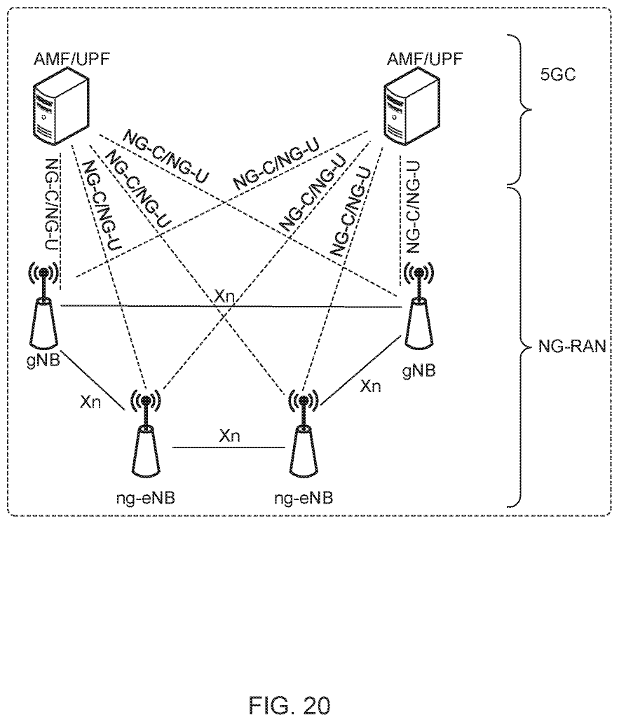

For example, the overall system architecture assumes an NG-RAN (Next Generation-Radio Access Network) that includes gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture is illustrated in FIG. 20 (see e.g., 3GPP TS 38.300 v15.6.0, section 4).

The user plane protocol stack for NR (see e.g., 3GPP TS 38.300, section 4.4.1) includes the PDCP (Packet Data Convergence Protocol, see clause 6.4 of TS 38.300), RLC (Radio Link Control, see clause 6.3 of TS 38.300) and MAC (Medium Access Control, see clause 6.2 of TS 38.300) sublayers, which are terminated in the gNB on the network side. Additionally, a new Access Stratum (AS) sublayer (SDAP, Service Data Adaptation Protocol) is introduced above the PDCP (see e.g., clause 6.5 of 3GPP TS 38.300). A control plane protocol stack is also defined for NR (see for instance TS 38.300, section 4.4.2). An overview of the Layer 2 functions is given in clause 6 of TS 38.300. The functions of the PDCP. RLC, and MAC sublayers are listed respectively in clauses 6.4, 6.3, and 6.2 of TS 38.300. The functions of the RRC layer are listed in clause 7 of TS 38.300.

For instance, the Medium Access Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. Examples of the physical channel include a Physical Random Access Channel (PRACH), a Physical Uplink Shared Channel (PUSCH), and a Physical Uplink Control Channel (PUCCH) as uplink physical channels, and a Physical Downlink Shared Channel (PDSCH), a Physical Downlink Control Channel (PDCCH), and a Physical Broadcast Channel (PBCH) as downlink physical channels.

Use cases/deployment scenarios for NR could include enhanced mobile broadband (eMBB), ultra-reliable low-latency communications (URLLC), and massive machine type communication (mMTC), which have diverse requirements in terms of data rates, latency, and coverage. For example, eMBB is expected to support peak data rates (20 Gbps for downlink and 10 Gbps for uplink) and user-experienced data rates on the order of three times what is offered by IMT-Advanced. On the other hand, in case of URLLC, the tighter requirements are put on ultra-low latency (0.5 ms for UL and DL each for user plane latency) and high reliability (1-10-5 within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, and number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacings of 15 KHz, 30 KHz, and 60 KHz . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and each carrier, resource grids of subcarriers and OFDM symbols are defined respectively for uplink and downlink. Each element in the resource grids is called a resource element and is identified based on the frequency index in the frequency domain and the symbol position in the time domain (see 3GPP TS 38.211 v15.6.0).

<Functional Split between NG-RAN and 5GC in 5G NR>

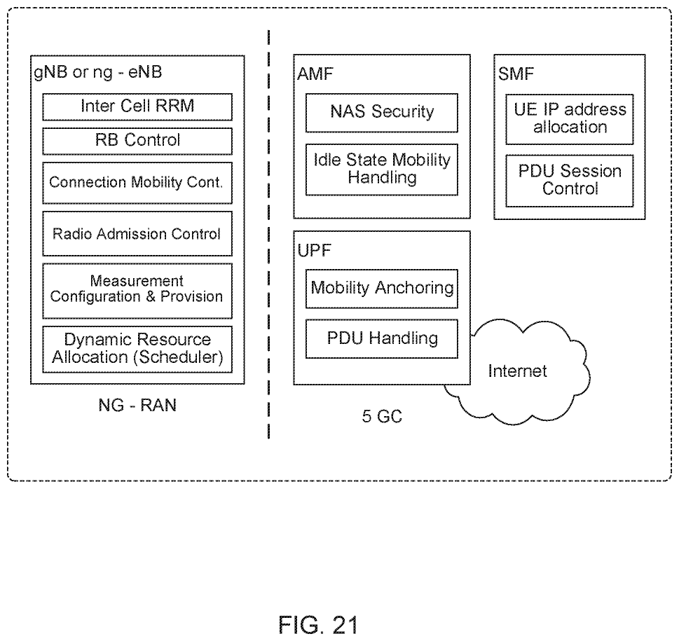

FIG. 21 illustrates the functional split between the NG-RAN and the 5GC. A logical node of the NG-RAN is gNB or ng-eNB. The 5GC includes logical nodes AMF, UPF, and SMF.

For example, gNB and ng-eNB hosts the following main functions:
Radio Resource Management functions such as Radio Bearer Control, Radio Admission Control, Connection Mobility Control, and dynamic allocation (scheduling) of both uplink and downlink resources to a UE;
IP header compression, encryption, and integrity protection of data;
Selection of an AMF during UE attachment in such a case when no routing to an AMF can be determined from the information provided by the UE;
Routing user plane data towards the UPF;
Routing control plane information towards the AMF;
Connection setup and release;
Scheduling and transmission of paging messages;
Scheduling and transmission of system broadcast information (originated from the AMF or an operation management maintenance function (OAM: Operation, Admission, Maintenance));
Measurement and measurement reporting configuration for mobility and scheduling;
Transport level packet marking in the uplink;
Session management;
Support of network slicing;
QoS flow management and mapping to data radio bearers;
Support of UEs in the RRC_INACTIVE state;
Distribution function for NAS messages;
Radio access network sharing;
Dual connectivity; and
Tight interworking between NR and E-UTRA.

The Access and Mobility Management Function (AMF) hosts the following main functions:
Function of Non-Access Stratum (NAS) signaling termination;
NAS signaling security;
Access Stratum (AS) security control;
Inter-Core Network (CN) node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing; and
Session Management Function (SMF) selection.

In addition, the User Plane Function (UPF) hosts the following main functions:
Anchor Point for intra-/inter-RAT mobility (when applicable);
External Protocol Data Unit (PDU) session point for interconnection to a data network;
Packet routing and forwarding;
Packet inspection and a user plane part of Policy rule enforcement;
Traffic usage reporting;
Uplink classifier to support routing traffic flows to a data network;
Branching point to support multi-homed PDU session;
QoS handling for user plane (e.g., packet filtering, gating. UL/DL rate enforcement);
Uplink traffic verification (SDF to QoS flow mapping); and
Function of downlink packet buffering and downlink data notification triggering.

Finally, the Session Management Function (SMF) hosts the following main functions:
Session management;
UE IP address allocation and management;
Selection and control of UPF;
Configuration function for traffic steering at the User Plane Function (UPF) to route traffic to a proper destination;
Control part of policy enforcement and QoS; and
Downlink data notification.

### <RRC Connection Setup and Reconfiguration Procedure>

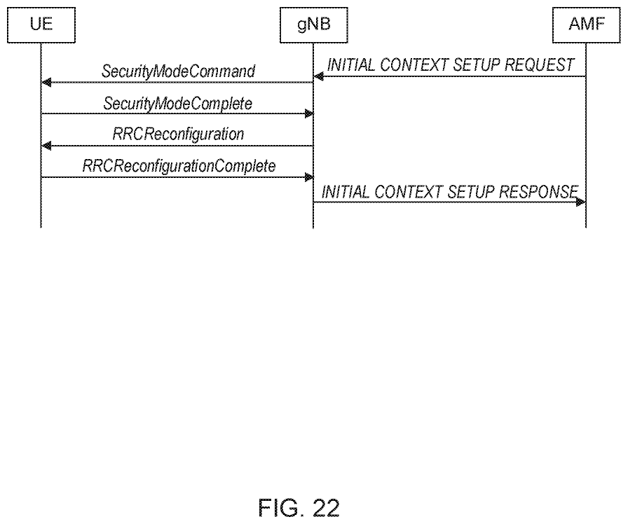

FIG. 22 illustrates some interactions between a UE, gNB, and AMF (a 5GC Entity) performed in the context of a transition of the UE from RRC_IDLE to RRC_CONNECTED for the NAS part (see TS 38 300 v15.6.0).

RRC is higher layer signaling (protocol) used for UE and gNB configuration. With this transition, the AMF prepares UE context data (which includes, for example, a PDU session context, security key, UE Radio Capability, UE Security Capabilities, and the like) and sends it to the gNB with an INITIAL CONTEXT SETUP REQUEST. Then, the gNB activates the AS security with the UE. This activation is performed by the gNB transmitting to the UE a Security ModeCommand message and by the UE responding to the gNB with the Security ModeComplete message. Afterwards, the gNB performs the reconfiguration to setup the Signaling Radio Bearer 2 (SRB2) and Data Radio Bearer(s) (DRB(s)) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not set up. Finally, the gNB indicates the AMF that the setup procedure is completed with INITIAL CONTEXT SETUP RESPONSE.

Thus, the present disclosure provides a 5th Generation Core (5GC) entity (e.g., AMF, SMF, or the like) including control circuitry, which, in operation, establishes a Next Generation (NG) connection with a gNodeB, and a transmitter, which in operation, transmits an initial context setup message to the gNodeB via the NG connection such that a signaling radio bearer between the gNodeB and a User Equipment (UE) is set up. Specifically, the gNodeB transmits Radio Resource Control (RRC) signaling including a resource allocation configuration Information Element (IE) to the UE via the signaling radio bearer. Then, the UE performs an uplink transmission or a downlink reception based on the resource allocation configuration.

### <<Usage Scenarios of IMT for 2020 and Beyond>

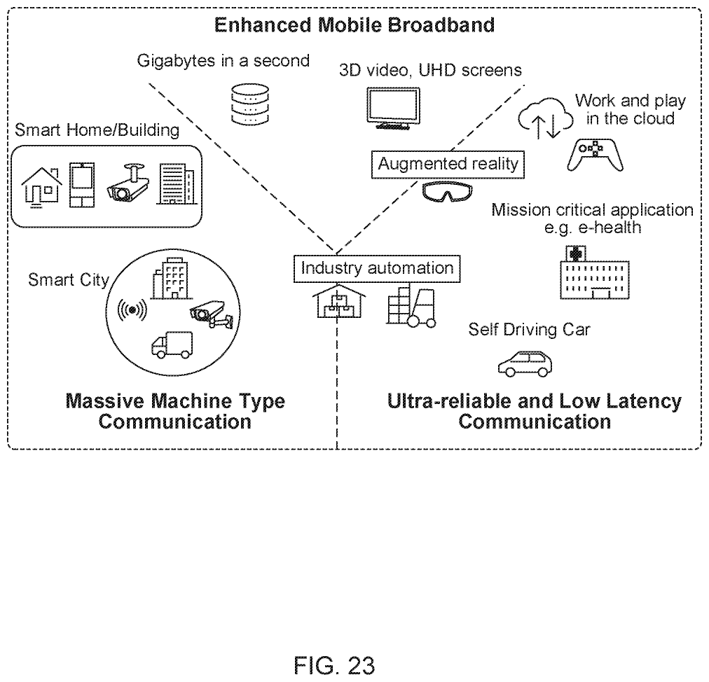

FIG. 23 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 23 illustrates some examples of envisioned usage scenarios for IMT for 2020 and beyond (see e.g., ITU-R M.2083 FIG. 2).

The URLLC use case has stringent requirements for capabilities such as throughput, latency and availability. The URLLC use case has been envisioned as one of the enablers for future vertical applications such as wireless control of industrial manufacturing or production processes, remote medical surgery, distribution automation in a smart grid, transportation safety. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a block error rate (BLER) of IE-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, or the like. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of IE-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, for example, for URLLC and mMTC, is high reliability or ultra-reliability. Several mechanisms can improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability improvement in general, regardless of particular communication scenarios.

For NR URLLC, further use cases with tighter requirements have been envisioned such as factory automation, transport industry and electrical power distribution. The tighter requirements are higher reliability (up to 10-6 level), higher availability, packet sizes of up to 256 bytes, time synchronization up to the extent of a few μs (where the value can be one or a few ρs depending on frequency range and short latency on the order of 0.5 to 1 ms (in particular a target user plane latency of 0.5 ms), depending on the use cases).

Moreover, for NR URLLC, several technology enhancements from physical layer perspective have been identified. Among these are PDCCH (Physical Downlink Control Channel) enhancements related to compact DCI, PDCCH repetition, increased PDCCH monitoring. Moreover. UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements are possible. The term “mini-slot” refers to a Transmission Time Interval (TTI) including a smaller number of symbols than a slot (a slot comprising fourteen symbols).

### <QoS Control>

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU sessions. For each UE, the NG-RAN establishes at least one Data Radio Bearer (DRB) together with the PDU session, e.g., as illustrated above with reference to FIG. 22. Further, additional DRB(s) for QoS flow(s) of that PDU session can be subsequently configured (it is up to NG-RAN when to do so). The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL Qos Flows with DRBs.

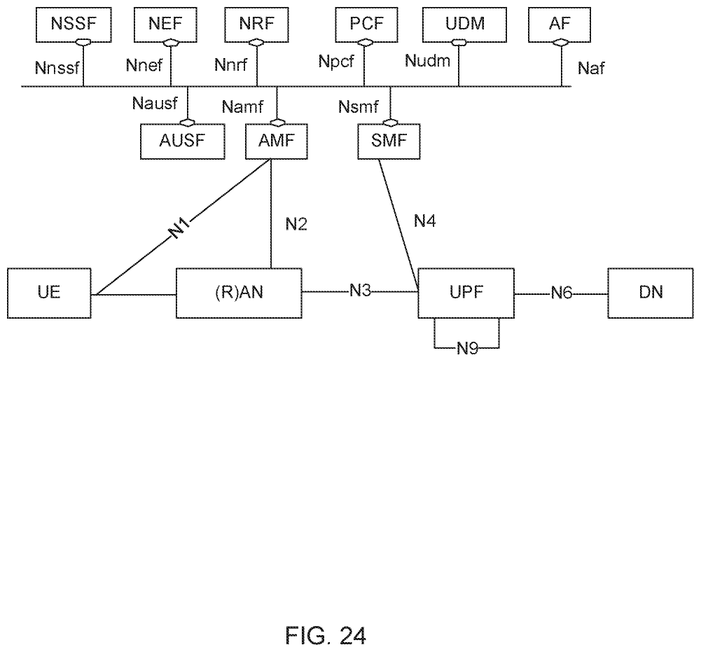

FIG. 24 illustrates a 5G NR non-roaming reference architecture (see TS 23.501 v16.1.0, section 4.23). An Application Function (AF) (e.g., an external application server hosting 5G services, exemplarily described in FIG. 23) interacts with the 3GPP Core Network in order to provide services, for example to support application influencing on traffic routing, accessing Network Exposure Function (NEF) or interacting with the policy framework for policy control (e.g., QoS control) (see Policy Control Function, PCF). Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 24 illustrates further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN, e.g., operator services, Internet access, or third party services). All of or a part of the core network functions and the application services may be deployed and running on cloud computing environments.

In the present disclosure, thus, an application server (e.g., AF of the 5G architecture), is provided that includes: a transmitter, which in operation, transmits a request containing a QoS requirement for at least one of URLLC, eMMB and inMTC services to at least one of functions (such as NEF, AMF, SMF, PCF, and UPF) of the 5GC to establish a PDU session including a radio bearer between a gNodeB and a UE in accordance with the QoS requirement; and control circuitry, which, in operation, performs the services using the established PD session.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSL a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programumable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RE (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

A base station according to an aspect of the present disclosure includes: control circuitry, which, in operation, determines, on resource allocation for a signal, information on the presence or absence of at least one configuration of a frequency gap and/or a reduction in transmission power for the signal; and transmission circuitry which, in operation, indicates the information to a terminal.

In an aspect of the present disclosure, the transmission circuitry indicates the information by downlink control information (DCI).

In an aspect of the present disclosure, the transmission circuitry indicates the information by higher layer signaling.

In an aspect of the present disclosure, the information is associated with at least one of a control resource set (CORESET), a search space, a control signal format, and/or a bandwidth part (BWP), each of which is configured by the higher layer signaling.

In an aspect of the present disclosure, the information includes information on at least one of a position of the frequency gap and/or a size of the frequency gap.

In an aspect of the present disclosure, the information includes information on an amount of the reduction in the transmission power.

In an aspect of the present disclosure, the at least one configuration is applied to a case where a resource to which the signal is assigned in the resource allocation includes a flexible symbol.

In an aspect of the present disclosure, the at least one configuration is applied to an entirety of the resource to which the signal is assigned.

In an aspect of the present disclosure, the at least one configuration is applied to the flexible symbol, in the resource to which the signal is assigned.

In an aspect of the present disclosure, the flexible symbol is a certain flexible symbol that is different from a first flexible symbol specified in Release 15 to Release 17, the certain flexible symbol being referred to as a second flexible symbol.

In an aspect of the present disclosure, the second flexible symbol is a symbol to which mapping of a periodic channel state information-reference signal (CSI-RS) and a semi-persistent CSI-RS is allowed.

A terminal according to an aspect of the present disclosure includes: reception circuitry, which, in operation, receives, on resource allocation for a signal, information on the presence or absence of at least one configuration of a frequency gap and/or a reduction in transmission power for the signal; and control circuitry, which, in operation, determines, based on the information, the at least one configuration of the frequency gap and/or the reduction in the transmission power.

A communication method according to an aspect of the present disclosure includes: determining, by a base station, on resource allocation for a signal, information on the presence or absence of at least one configuration of a frequency gap and/or a reduction in transmission power for the signal; and indicating, by the base station, the information to a terminal.

A communication method according to an aspect of the present disclosure includes: receiving, by a terminal, on resource allocation for a signal, information on the presence or absence of at least one configuration of a frequency gap and/or a reduction in transmission power for the signal; and determining, by the terminal, based on the information, the at least one configuration of the frequency gap and/or the reduction in the transmission power.

The disclosure of Japanese Patent Application No. 2021-196917, filed on Dec. 3, 2021, including the specification, drawings and abstract, is incorporated herein by reference in its entirety.

### INDUSTRIAL APPLICABILITY

An aspect of the present disclosure is useful for mobile communication systems, Reference Signs List
100, 300 Base station
101 Frequency gap information generator
102, 302 DCI generator
103, 303 Higher layer signal generator
104, 207 Error correction encoder
105, 208 Modulator
106, 209 Signal assigner
107, 210 Transmitter
108, 201 Receiver
109, 202 Signal separator
110, 204 Demodulator
111, 205 Error correction decoder
200, 400 Terminal
203, 401 DCI receiver
206 Frequency gap information receiver
301 Transmission-power control information generator
402 Transmission-power control information receiver

1. A base station, comprising:
control circuitry, which, in operation, determines, on resource allocation for a signal, information on the presence or absence of at least one configuration of a frequency gap and/or a reduction in transmission power for the signal; and
transmission circuitry, which, in operation, indicates the information to a terminal.

2. The base station according to claim 1, wherein the transmission circuitry indicates the information by downlink control information (DCI).

3. The base station according to claim 1, wherein the transmission circuitry indicates the information by higher layer signaling.

4. The base station according to claim 3, wherein the information is associated with at least one of a control resource set (CORESET), a search space, a control signal format, and/or a bandwidth pail (BWP), each of which is configured by the higher layer signaling.

5. The base station according to claim 1, wherein the information includes information on at least one of a position of the frequency gap and/or a size of the frequency gap.

6. The base station according to claim 1, wherein the information includes information on an amount of the reduction in the transmission power.

7. The base station according to claim 1, wherein the at least one configuration is applied to a case where a resource to which the signal is assigned in the resource allocation includes a flexible symbol.

8. The base station according to claim 7, wherein the at least one configuration is applied to an entirety of the resource to which the signal is assigned.

9. The base station according to claim 7, wherein the at least one configuration is applied to the flexible symbol, in the resource to which the signal is assigned.

10. The base station according to claim 7, wherein the flexible symbol is a certain flexible symbol that is different from a first flexible symbol specified in Release 15 to Release 17, the certain flexible symbol being referred to as a second flexible symbol.

11. The base station according to claim 10, wherein the second flexible symbol is a symbol to which mapping of a periodic channel state information-reference signal (CSI-RS) and a semi-persistent CSI-RS is allowed.

12. A terminal, comprising:
reception circuitry, which, in operation, receives, on resource allocation for a signal, information on the presence or absence of at least one configuration of a frequency gap and/or a reduction in transmission power for the signal; and
control circuitry, which, in operation, determines, based on the information, the at least one configuration of the frequency gap and/or the reduction in the transmission power.

13. A communication method, comprising:
determining, by a base station, on resource allocation for a signal, information on the presence or absence of at least one configuration of a frequency gap and/or a reduction in transmission power for the signal; and
indicating, by the base station, the information to a terminal.

14. A communication method, comprising:
receiving, by a terminal, on resource allocation for a signal, information on the presence or absence of at least one configuration of a frequency gap and/or a reduction in transmission power for the signal; and
determining, by the terminal, based on the information, the at least one configuration of the frequency gap and/or the reduction in the transmission power.
